(19) United States
(12) Patent Application Publication
(10) Pub. No.: US 2016/0270018 A1
(43) Pub. Date: Sep. 15, 2016

(54) SYNCHRONOUS LOW-LATENCY MEDIA ACCESS CONTROL

(71) Applicant: QUALCOMM Incorporated, San Diego, CA (US)

(72) Inventors: Linhai HE, San Diego, CA (US); Rashid Ahmed Akbar ATTAR, San Diego, CA (US); Bibhu MOHANTY, San Diego, CA (US); Joseph Binamira SORIAGA, San Diego, CA (US); Maksim KRASNYANSKIY, San Diego, CA (US); Yacob COHEN-ARAZI, San Diego, CA (US); Rajesh KUMAR, San Diego, CA (US); Ron SCHNEIDER, Carlsbad, CA (US); Wenjia LAI, San Diego, CA (US)

(21) Appl. No.: 15/066,954

(22) Filed: Mar. 10, 2016

Related U.S. Application Data
(60) Provisional application No. 62/133,155, filed on Mar. 13, 2015.

(51) Int. Cl. H04W 56/00; H04W 74/08; H04W 36/30; H04L 5/00; H04W 74/04; H04W 36/38

(52) U.S. Cl. CPC H04W 56/0025; H04W 74/04; H04W 36/38; H04W 36/30; H04L 5/0007; H04W 74/0833; H04W 84/12

(57) ABSTRACT

Various aspects are provided for low-latency wireless local area networks (WLANs). An access point (AP) may transmit a downlink pilot signal for synchronization of the AP with one or more wireless stations. The AP may receive an uplink control block synchronized with the downlink pilot signal including a reservation for uplink transmission from a first wireless station of the one or more wireless stations. The reservation may include an uplink pilot signal and a modulated pilot signal and indicate that the first wireless station has traffic for uplink transmission to the AP. The AP may schedule the first wireless station for uplink transmission during a traffic block after the uplink control block. The AP may estimate a wireless channel to the first wireless station based on the pilot signal and the modulated pilot signal. Other low-latency aspects apply to WLANs in which the AP and associated wireless stations are synchronized.

### RELATED APPLICATIONS

This application claims priority from U.S. Provisional Application No. 62/133,155 entitled “SYNCHRONOUS LOW-LATENCY MEDIA ACCESS CONTROL,” filed on Mar. 13, 2015, which is incorporated herein by reference in its entirety.

### BACKGROUND

The present disclosure relates generally to telecommunications, and specifically to low-latency wireless local area networks.

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs.

For some applications, the latency of existing WLANs may be too high. For example, industrial applications involving sensors and/or robotic controls may have a need to transmit control data with very low latency. Existing media access control (MAC) protocols, however, may be optimized to maximize throughput at the expense of latency. Accordingly, control data, which may be relatively small in size, may be delayed by buffering, overhead, and other characteristics of existing MAC protocols. Further, some low-latency applications may incorporate numerous wireless stations. Existing MAC protocols may permit collisions between transmissions between different stations. As more stations are added, the number of collisions increases and results in greater latency. Accordingly, it may be desirable to provide a WLAN that supports reliable low-latency applications for numerous wireless stations.

### SUMMARY

Various aspects are provided for low-latency wireless local area networks (WLANs). An access point (AP) may transmit a downlink pilot signal for synchronization of the AP with one or more wireless stations. The AP may receive an uplink control block synchronized with the downlink pilot signal including a reservation for uplink transmission from a first wireless station of the one or more wireless stations. The reservation may include an uplink pilot signal and a modulated pilot signal and indicate that the first wireless station has traffic for uplink transmission to the AP. The AP may schedule the first wireless station for uplink transmission during a traffic block after the uplink control block. In an aspect, the AP may estimate a wireless channel to the first wireless station based on the pilot signal and the modulated pilot signal. Other low-latency aspects apply to WLANs in which the AP and associated wireless stations are synchronized.

In an aspect, the disclosure provides a method for wireless communications. The method may include transmitting, by an AP, a downlink pilot signal for synchronization of the AP with one or more wireless stations. The method may include receiving an uplink control block synchronized with the downlink pilot signal including a reservation for uplink transmission from a first wireless station of the one or more wireless stations, wherein the reservation includes an uplink pilot signal and a modulated pilot signal, and wherein the reservation indicates that the first wireless station has traffic for uplink transmission to the AP. The method may optionally include estimating a wireless channel to the first wireless station based on the pilot signal and the modulated pilot signal. The method may include scheduling the first wireless station for uplink transmission during a traffic block after the uplink control block.

In an aspect, the disclosure provides an apparatus for wireless communications. The apparatus may include a transceiver, a memory that stores instructions, and a processor communicatively coupled to the transceiver and the memory. The processor may be configured to execute the instructions to transmit, via the transceiver, from an AP, a downlink pilot signal for synchronization of the AP with one or more wireless stations. The processor may also be configured to execute the instructions to receive an uplink control block synchronized with the downlink pilot signal including a reservation for uplink transmission from a first wireless station of the one or more wireless stations, wherein the reservation includes an uplink pilot signal and a modulated pilot signal, and wherein the reservation indicates that the first wireless station has traffic for uplink transmission to the AP. The processor may also be configured to execute the instructions to schedule the first wireless station for uplink transmission during a traffic block after the uplink control block. The processor may also optionally be configured to estimate a wireless channel to the first wireless station based on the pilot signal and the modulated pilot signal.

In an aspect, the disclosure provides an apparatus for wireless communications. The apparatus may include means for transmitting, by an AP, a downlink pilot signal for synchronization of the AP with one or more wireless stations. The apparatus may include means for receiving an uplink control block synchronized with the downlink pilot signal including a reservation for uplink transmission from a first wireless station of the one or more wireless stations, wherein the reservation includes an uplink pilot signal and a modulated pilot signal, and wherein the reservation indicates that the first wireless station has traffic for uplink transmission to the AP. The apparatus may optionally include means for estimating a wireless channel to the first wireless station based on the pilot signal and the modulated pilot signal. The apparatus may include means for scheduling the first wireless station for uplink transmission during a traffic block after the uplink control block.

In an aspect, the disclosure provides a computer-readable medium storing computer executable code. The computer-readable medium may include code for transmitting, by an AP, a downlink pilot signal for synchronization of the AP with one or more wireless stations. The computer-readable medium may include code for receiving an uplink control block synchronized with the downlink pilot signal including a reservation for uplink transmission from a first wireless station of the one or more wireless stations, wherein the reservation includes an uplink pilot signal and a modulated pilot signal, and wherein the reservation indicates that the first wireless station has traffic for uplink transmission to the AP. The computer-readable medium may optionally include code for estimating a wireless channel to the first wireless station based on the pilot signal and the modulated pilot signal. The computer-readable medium may include code for scheduling the first wireless station for uplink transmission during a traffic block after the uplink control block.

In an aspect, the disclosure provides a method for wireless communications. The method may include synchronizing a wireless station with a first AP based on a downlink pilot signal received from the first AP on a wireless channel. The method may include transmitting, during an uplink control block synchronized with the downlink pilot signal, a reservation indicating to the first AP that the wireless station has traffic for uplink transmission, wherein the reservation includes an uplink pilot signal and a modulated pilot signal. The method may include receiving an uplink grant during a traffic block following the uplink control block, the uplink grant indicating a time period within an uplink frame of the traffic block for uplink transmission by the wireless station. The method may include transmitting, on the wireless channel, an uplink frame synchronized with the downlink pilot signal during the time period based on the uplink grant.

In an aspect, the disclosure provides an apparatus for wireless communications. The apparatus may include a transceiver, memory that stores instructions, and a processor communicatively coupled to the memory and the processor. The processor may be configured to execute the instructions to synchronize a wireless station with a first AP based on a downlink pilot signal received from the first AP on a wireless channel. The processor may also be configured to execute the instructions to transmit, via the transceiver, during an uplink control block synchronized with the downlink pilot signal, a reservation indicating to the first AP that the wireless station has traffic for uplink transmission, wherein the reservation includes an uplink pilot signal and a modulated pilot signal. The processor may also be configured to execute the instructions to receive, via the transceiver, an uplink grant during a traffic block following the uplink control block, the uplink grant indicating a time period within an uplink frame of the traffic block for uplink transmission by the wireless station. The processor may also be configured to execute the instructions to transmit, on the wireless channel, via the transceiver, an uplink frame synchronized with the downlink pilot signal during the time period based on the uplink grant.

In an aspect, the disclosure provides an apparatus for wireless communications. The apparatus may include means for synchronizing a wireless station with a first AP based on a downlink pilot signal received from the first AP on a wireless channel. The apparatus may include means for transmitting, during an uplink control block synchronized with the downlink pilot signal, a reservation indicating to the first AP that the wireless station has traffic for uplink transmission, wherein the reservation includes an uplink pilot signal and a modulated pilot signal. The apparatus may include means for receiving an uplink grant during a traffic block following the uplink control block, the uplink grant indicating a time period within an uplink frame of the traffic block for uplink transmission by the wireless station. The apparatus may include means for transmitting, on the wireless channel, an uplink frame synchronized with the downlink pilot signal during the time period based on the uplink grant.

In an aspect, the disclosure provides a computer-readable medium storing computer-executable code. The computer-readable medium may include code for synchronizing a wireless station with a first AP based on a downlink pilot signal received from the first AP on a wireless channel. The computer-readable medium may include code for transmitting, during an uplink control block synchronized with the downlink pilot signal, a reservation indicating to the first AP that the wireless station has traffic for uplink transmission, wherein the reservation includes an uplink pilot signal and a modulated pilot signal. The computer-readable medium may include code for receiving an uplink grant during a traffic block following the uplink control block, the uplink grant indicating a time period within an uplink frame of the traffic block for uplink transmission by the wireless station. The computer-readable medium may include code for transmitting, on the wireless channel, an uplink frame synchronized with the downlink pilot signal during the time period based on the uplink grant.

In an aspect, the disclosure provides a method of rate control for wireless communications. The method may include receiving a first packet encoded with a first modulation and coding scheme from a transmitting node. The method may further include estimating a signal-to-noise ratio (SNR) based on the first packet. The method may also include determining a frame error rate (FER) target for a next packet based on whether the first packet was successfully decode. The method may additionally include computing an SNR threshold for each of a plurality of modulation and coding schemes including the first modulation and coding scheme to achieve the frame error rate target based on historical FER and SNR information. The method may further include selecting a second modulation and coding scheme that is associated with a SNR threshold that is less than or equal to the estimated SNR. The method may also include providing an indication of the second modulation and coding scheme to the transmitting node. In an aspect, the method may also include: decoding the first packet by determining a most likely decoded path having a first likelihood ratio; estimating a FER for the first modulation and coding scheme based on the first likelihood ratio and at least one other likelihood ratio of an alternative decoded path for the first packet; and updating the historical FER and SNR information based on the estimated SNR and the estimated FER for the first packet.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of a wireless local area network (WLAN) deployment;

FIG. 2 is a timing diagram illustrating an example of a channel structure for a low-latency serving channel.

FIG. 3 is a block diagram illustrating an example access point;

FIG. 4 is a block diagram illustrating an example wireless station;

FIG. 5A is a timing diagram illustrating an example traffic block for uplink transmissions;

FIG. 5B is a diagram illustrating an example uplink grant;

FIG. 6A is a timing diagram illustrating an example traffic block for downlink transmissions;

FIG. 6B is a diagram illustrating an example header for a downlink aggregated frame (DAF).

FIG. 6C is a diagram illustrating an example aggregated media access control (MAC) protocol data unit (MPDU);

FIG. 7 is a diagram illustrating an example unlink control block;

FIG. 8 a flow chart illustrating an example of aspects of a method performed by an AP for providing low-latency synchronous communications;

FIG. 9 a flow chart illustrating an example of aspects of a method performed by a wireless station for providing low-latency synchronous communications;

FIG. 10 is a block diagram illustrating an example of a rate control component;

FIG. 11 is a conceptual diagram illustrating example frame error rate (FER)/signal-to-noise-ratio (SNR) curves;

FIG. 12 a flow chart illustrating an example of aspects of a method of determining a modulation and coding scheme;

FIG. 13 is a message diagram illustrating an example of a method for performing handover of a station;

FIG. 14 is a message diagram illustrating an example of another method for performing handover of a station;

FIG. 15 is a message diagram illustrating an example of another method for performing handover of a station; and

FIG. 16 is a block diagram illustrating an example of a processing system configured for providing low-latency communications.

### DETAILED DESCRIPTION

Various concepts will be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details. In some instances, well known structures and components are shown in block diagram form in order to avoid obscuring the various concepts presented throughout this disclosure.

The present disclosure describes various aspects for providing a WLAN that supports low-latency applications. In an aspect, a network that supports low-latency applications may have a goal of providing wireless communications with a round-trip time of, for example, less than 2 milliseconds. For comparison, a Wi-Fi network with a single wireless station may have a round-trip time of at least 1.5 milliseconds. As the number of Wi-Fi stations grows, the number of collisions may grow quickly and further increase the round-trip time. For simplicity, a WLAN or network that supports low-latency applications may be referred to as a low-latency WLAN or a low-latency network, respectively.

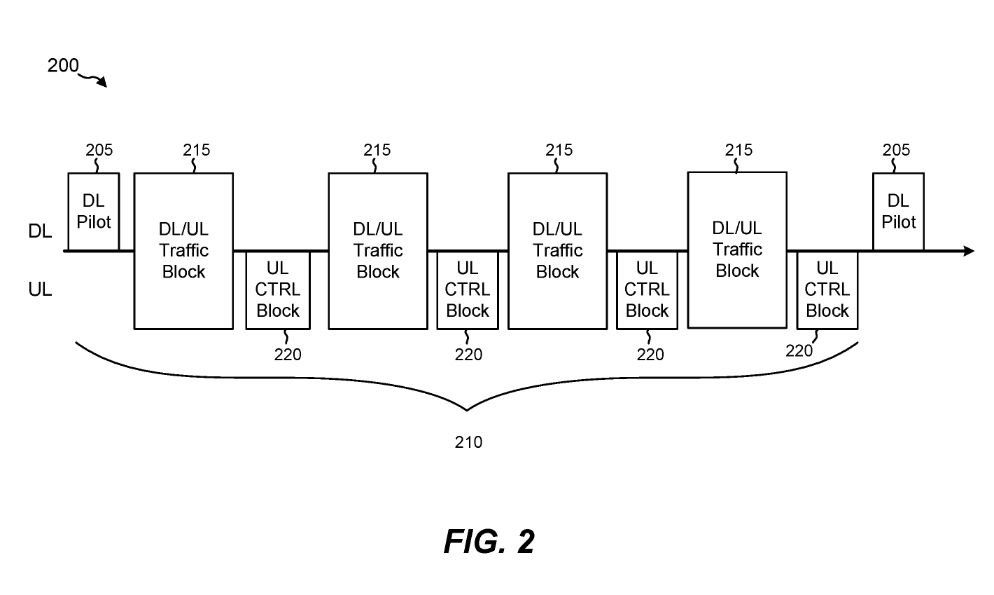

The aspects described in the present disclosure for providing a low-latency WLAN may include multiple methods that can be used to reduce or minimize latency associated with wireless communications. In one of these methods, a time-synchronized media access control protocol may be used for both uplink and downlink communications over a wireless channel (e.g., a frequency band). An AP may schedule all transmissions on the channel to reduce latency by avoiding collisions between transmissions from different stations. The AP may transmit a periodic pilot signal that stations (STAs) may use for synchronization with the AP. The synchronization may allow for multiple STAs to access the channel concurrently using orthogonal frequency division multiple access (OFDMA). STAs may use an uplink (UL) control block (see e.g., UL CTRL Block 220 in FIG. 2) to concurrently transmit reservations indicating that each STA has data for an uplink transmission. The AP may schedule the uplink or downlink transmissions during a traffic block.

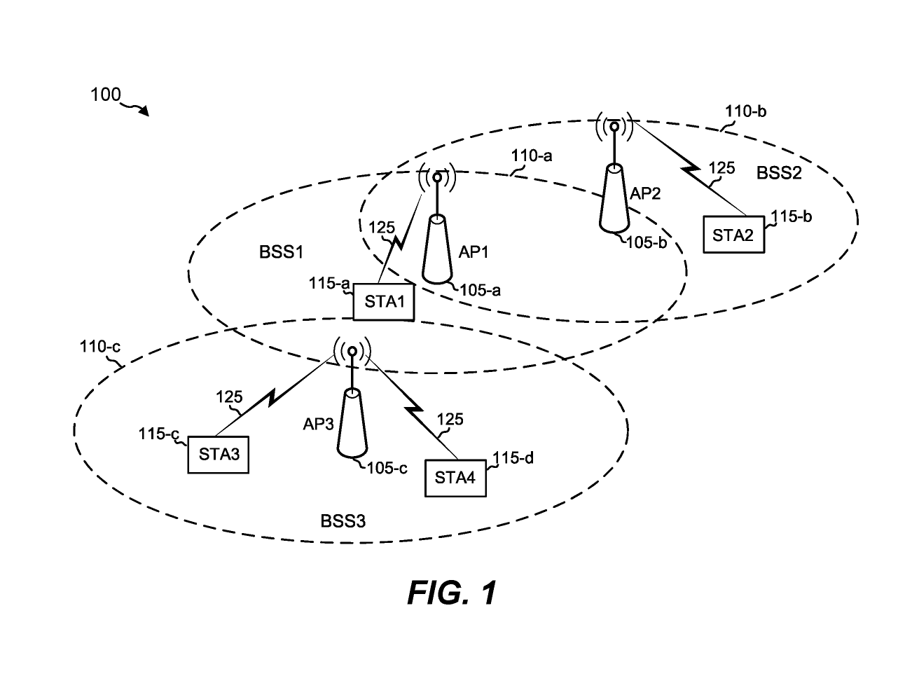

FIG. 1 is a conceptual diagram 100 illustrating an example of a wireless local area network (WLAN) deployment that may provide a low-latency WLAN. The WLAN may include one or more access points (APs) and one or more mobile stations (STAs) associated with a respective AP. In this example, there are three APs deployed: AP1 105-a in basic service set (BSS1), AP2 105-b in BSS2, and AP3 105-c in BSS3. AP1 105-a may have an associated STA1 115-a and coverage area 110-a, AP2 105-b may have an associated STA2 115-b and coverage area 110-b, and AP3 105-c may have associated STA3 115-c and STA4 115-d and coverage area 110-c. In this example, the coverage area of AP1 overlaps part of the coverage area of AP2 such that AP1 and AP2 are within the overlapping portion of the coverage areas. In addition, the coverage area of AP1 also overlaps part of the coverage area of AP3; however, neither AP1 nor AP3 is within the overlapping portion of the coverage areas. Thus, while transmissions from AP1 may reach AP2 and vice versa, transmissions from AP1 and AP3 may not reach each other. The number of BSSs, APs, and STAs, and the coverage areas of the APs described in connection with the WLAN deployment of FIG. 1 are provided by way of illustration and not of limitation. Moreover, aspects of the different methods for providing low-latency communications are described based on the example WLAN deployment of FIG. 1.

The APs (e.g., AP1 105-a, AP2 105-b, AP3 105-c) shown in FIG. 1 are generally fixed terminals that provide backhaul services to STAs within its coverage area or region. In some applications, however, the AP may be a mobile or non-fixed terminal.

The STAs (e.g., STA1 115-a, STA2 115-b, STA3 115-c, and STA4 115-d) shown in FIG. 1, which may be fixed, non-fixed, or mobile terminals, utilize the backhaul services of their respective AP to connect to a network, such as the Internet. The STAs may also communicate between themselves and/or with a control station, which may be connected to one or more APs via a backhaul. Examples of an STA include, but are not limited to: a cellular phone, a smart phone, an industrial robot, a manufacturing control system, a sensor, a drone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the central communication coordination and/or backhaul services of an AP. In an aspect, a STA may execute a low-latency application that may benefit from network communications with low round-trip times. For example, a low-latency application may include a remote control application, a coordination application, or another application involving time-sensitive information. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to any suitable wireless apparatus regardless of its specific nomenclature.

In an aspect, one or more of the APs (e.g., AP1 105-a) may be an authorization AP used to grant access to the low-latency WLAN. For example, an authorization AP may communicate with STAs using a traditional IEEE 802.11 (Wi-Fi) protocol on a dedicated boot-up wireless channel. An STA (e.g., STA1 115-a) may access the authorization AP by performing a random access procedure on the boot-up wireless channel. The authorization AP1 105-a may perform authentication and authorization procedures with the STA to ensure the STA is allowed to access the low-latency WLAN. The authorization AP1 105-a may then handover the STA to a serving AP (e.g., AP2 105-b, AP3 105-c) for low-latency communications on a low-latency serving channel. A low-latency serving channel may be a frequency band dedicated to a low-latency MAC protocol. In an aspect, each serving AP may be configured to use a different low-latency serving channel from neighboring APs with which the coverage areas overlaps.

Each of STA1 115-a, STA2 115-b, STA3 115-c, and STA4 115-d may be implemented with a protocol stack. The protocol stack can include a physical layer for transmitting and receiving data in accordance with the physical and electrical specifications of the wireless channel, a media access control (MAC) layer for managing access to the wireless channel, a network layer for managing source to destination data transfer, a transport layer for managing transparent transfer of data between end users, and any other layers necessary or desirable for establishing or supporting a connection to a network.

Each of AP1 105-a, AP2 105-b, and AP3 105-c can include software applications and/or circuitry to enable associated STAs to connect to a network via wireless communication links 125. The APs can send frames to their respective STAs and receive frames from their respective STAs to communicate data and/or control information (e.g., signaling).

Each of AP1 105-a, AP2 105-b, and AP3 105-c can establish a wireless communication link 125 with an STA that is within the coverage area of the AP. Wireless communication links 125 can comprise communications channels that can enable both uplink and downlink communications. When a STA has been handed over to a serving AP, the STA may be associated with the serving AP. Once associated, a wireless communication link 125 can be established between the AP and the STA such that the AP and the associated STA can exchange frames or messages through direct communications channel. The communication channel for each AP may be shared among any STAs associated with the AP. Neighbor APs that have overlapping coverage area with an AP may be configured to use different channels. For example, each of AP1 105-a, AP2 105-b, and AP3 105-c may each use a different channel. In an aspect where a low-latency network includes additional APs that do not have overlapping coverage areas with AP1 105-a, AP2 105-b, and AP3 105-c, the additional AP may reuse a channel of an AP when the respective coverage areas of the APs do not overlap.

A serving AP such as AP2 105-b may provide for wireless communications with an STA 115. The AP2 105-b may transmit a downlink pilot signal for synchronization of the AP2 105-b with one or more of STA 115 (e.g., STA2 115-b). Further, the AP2 105-b may receive an uplink control block including a reservation for uplink transmission from at least STA2 115-b, wherein reservations included in the uplink control block are received on a plurality of orthogonal frequency-division multiple access (OFDMA) tones, and wherein each reservation included in the uplink control block indicates that the corresponding STA 115 has traffic for uplink transmission. The AP2 105-b may schedule each of the one or more STAs 115 having a reservation included in the uplink control block for uplink transmission during a traffic block following the uplink control block.

An STA (e.g., STA2 115-b) may synchronize with AP2 105-b based on a downlink pilot signal received from AP2 105-b on a wireless communication link 125. The STA2 115-b may transmit, during an uplink control block, a reservation indicating to the AP2 105-b that the STA2 115-b has traffic for uplink transmission, the uplink control block including a plurality of OFDMA tones of the wireless communication link 125, and the uplink reservation being associated with a subset of the OFDMA tones based on an address of the STA2 115-b. The STA2 115-b may receive an uplink grant during a traffic block following the uplink control block, the uplink grant indicating a time period within an uplink frame of the traffic block for uplink transmission by the STA2 115-b. The STA2 115-b may transmit, on the wireless channel, an uplink MPDU preceded by an uplink pilot during the time period.

While aspects for providing a low-latency network are described in connection with a WLAN deployment or the use of IEEE 802.11-compliant networks and related terminology, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for protecting the reception of response frames or messages from interference or similar effects resulting from transmissions by nearby devices may be applicable to any suitable wireless network regardless of the coverage range and the wireless access protocols utilized.

FIG. 2 shows a timing diagram 200 illustrating an example of a channel structure for a low-latency serving channel. As shown in FIG. 2, downlink and uplink transmissions may be time duplexed on the low-latency serving channel. A serving AP (e.g., AP2 105-b) may periodically transmit a downlink pilot 205 (shown as DL Pilot 205 in FIG. 2). The downlink pilot 205 may be a fixed transmission pattern that may be used by an STA (e.g., STA2 115-b) to synchronize with the serving AP2 105-b. The downlink pilots 205 may define a period 210 of the low-latency serving channel. In an aspect, the period 210 may be approximately 1 millisecond (ms). For example, the period 210 shown in FIG. 2 may be 1088 microseconds (μs), although periods of different durations are also possible. Between downlink pilots 205, the period 210 may be divided into traffic blocks 215 (shown as DL/UL Traffic Block in FIG. 2) that carry either uplink or downlink transmissions (e.g., uplink or downlink frames) and uplink control blocks 220 (shown as UL CTRL Block 220 in FIG. 2) that carry reservations for STAs. The serving AP2 105-b may schedule uplink and/or downlink transmissions in each traffic block 215. In an aspect, each traffic block 215 may have a duration of approximately 220 μs, although durations may vary. The uplink control blocks 220 may be transmitted periodically between traffic blocks 215. For example, the uplink control blocks 220 may alternate with the traffic blocks 215. During the uplink control blocks 220, each STA may transmit a signal indicating whether the STA has data for an uplink transmission (e.g., uplink traffic). Such signals may be referred to as reservations. In an aspect, each uplink control block 220 may have a duration of approximately 48 μs, although durations may vary.

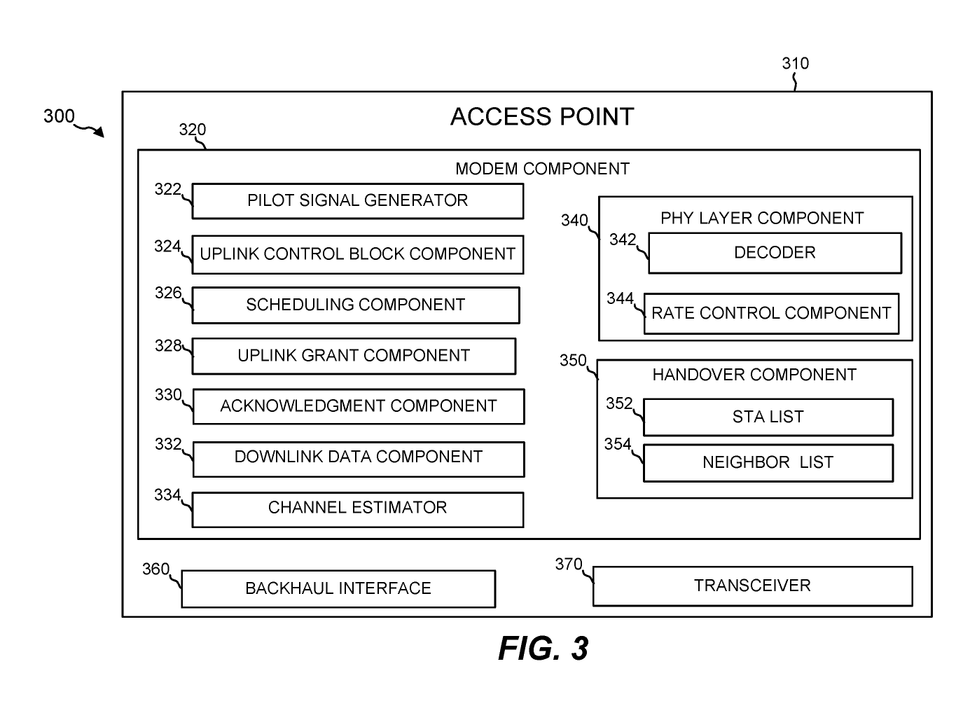

FIG. 3 illustrates a block diagram 300 showing an example access point 310. The access point 310 may be an example of a serving AP2 105-b (FIG. 1) and include modem component 320, a physical layer (PHY layer) component 340, a handover component 350, a backhaul interface 360, and a transceiver 370.

The modem component 320 may be or may include one or more processors configured for performing downlink and uplink transmissions within the channel period 210 (FIG. 2). The modem component 320, may include a pilot signal generator 322 for generating the downlink pilots 205, an uplink control block component 324 for determining which STA 115 have data for uplink transmissions, a scheduling component 326 for scheduling each of the STA 115 that have data for uplink transmissions, an uplink grant component 328 for generating an uplink grant indicating the uplink scheduling to the STAs 115, an acknowledgment component 330 for generating a block acknowledgment including an indication of whether each uplink transmission is correctly received by the access point 310, a downlink data component 332 for storing downlink data, and a channel estimator 334 for estimating a channel to a wireless station based on a pilot signal and a modulated pilot signal.

The pilot signal generator 322 may include hardware and/or software code executable by a processor for generating the downlink pilot 205 in a regular or periodic manner. The pilot signal generator 322 may include, for example, an oscillator and/or other timing component (not shown) for tracking time. The pilot signal generator 322 may generate the downlink pilot 205 at the start of each period 210.

The uplink control block component 324 may include hardware and/or software code executable by a processor for determining which STA associated with the access point 310 have data for uplink transmissions based on a received uplink control block 220. The uplink control block component 324 may determine whether a subset of tones or subcarriers in the uplink control block 220 assigned or otherwise corresponding to each STA indicates a reservation for uplink transmission. In an aspect, the uplink control block may indicate a reservation for a STA when each tone in the subset for the STA includes a pilot signal in a first symbol followed by a phase modulated pilot signal in a second symbol. For example, the phase modulated pilot signal may be the same as the pilot signal (e.g., +1 phase modulation) when the STA has data for an uplink transmission, and may be modulated to be the opposite (e.g., −1 phase modulation) when the STA does not have data for an uplink transmission. Accordingly, the uplink control block component 324 may compare a first received symbol on each tone to a second received symbol on a corresponding tone during the uplink control block 220 to determine whether the two symbols combined indicate a reservation or not for the STA corresponding to the symbols. In an aspect, the phase modulated pilot signal may be transmitted on a different tone than the pilot signal. The uplink control block component 324 may compare the symbols received on the respective tones for each STA to determine whether the STA has data for an uplink transmission.

The scheduling component 326 may include hardware and/or software code executable by a processor for scheduling each STA that transmitted a reservation in the uplink control block 220. In an aspect, transmission resources (e.g., time) in a traffic block may be limited. Accordingly, the scheduling component 326 may allocate resources among the STA based on a priority. In another aspect, the scheduling component 326 may also schedule downlink transmissions during the traffic block 215 when the downlink data component 332 had downlink data. The scheduling component 326 may also prioritize between downlink and uplink traffic.

The uplink grant component 328 may include hardware and/or software code executable by a processor for generating an uplink grant indicating when each STA is allowed to transmit data in an uplink transmission. The uplink grant component 328 may transmit the uplink grant at the start of the traffic block 215 or the start of an uplink frame within the traffic block 215.

The acknowledgment component 330 may include hardware and/or software code executable by a processor for generating a block acknowledgement (e.g., BA) including an indication of whether each uplink transmission is correctly received. The acknowledgment component 330 may determine whether each uplink transmission is correctly received from decoder 342 during the traffic block. Once the duration of each of the scheduled uplink transmissions has expired, the acknowledgment component 330 may generate a block acknowledgment that may be transmitted to each of the STAs. In an aspect, the block acknowledgment may be a bit-map including one bit for each STA, where the bit indicates whether the uplink transmission was received for that particular STA. The block acknowledgment may be transmitted with a low modulation and coding scheme (MCS) by the access point 310 for high reliability, that is, to ensure that it is properly received by the appropriate STA(s).

The downlink data component 332 may include hardware and/or software code executable by a processor for generating a downlink aggregated frame (DAF) for transmitting downlink traffic. The downlink data component 332 may store downlink data received from stations 115 or backhaul interface 360 for transmission to one or more stations 115 associated with the access point 310. The DAF may include a header and a plurality of MAC protocol data units (PDUs). The downlink data component 332 may generate the MAC PDUs based on the downlink data and generate a header identifying each of the MAC PDUs in a downlink frame.

The channel estimator 334 may include hardware and/or software code executable by a processor for estimating a wireless channel to the first wireless station based on a pilot signal and a modulated pilot signal. The pilot signal may be received on at least one of a plurality of OFDMA tones during a first symbol of the uplink control block, and may be a known signal. The pilot signal may be used to coherently demodulate the modulated pilot signal, which may also be received on at least one of a plurality of OFDMA tones. The pilot signal and the demodulated pilot signal may then be combined for channel estimation. The channel estimator 334 may be able to estimate the channel across the plurality of OFDMA tones.

The PHY layer component 340 may include hardware and/or software code executable by a processor for handling physical layer transmission properties such as modulation rate and decoding. In an aspect, the PHY layer component 340 may include a decoder 342 and a rate control component 344. The decoder 342 may receive a signal from the transceiver 370 and determine a MAC PDU. In an aspect, the decoder 342 may be a Viterbi decoder that may be configured to provide a likelihood ratio for a most likely path (e.g., decoding path) and also for one or more alternative paths. The decoder 342 may also estimate a signal-to-noise ratio (SNR) for a received transmission.

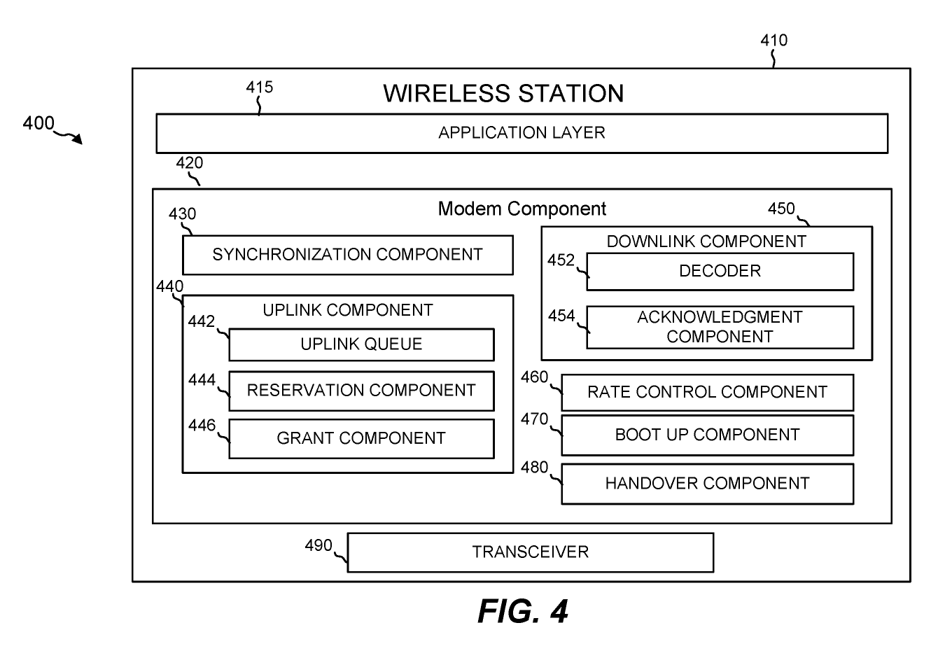

The rate control component 344 may include hardware and/or software code executable by a processor for determining a modulation and coding scheme to use for transmissions. In an aspect, the rate control component 344 may be in communication with a rate control component 460 (FIG. 4) at each STA 115 and signal a modulation and coding scheme and/or receive a signaled modulation and coding scheme. For example, the rate control component 344 may receive signaling indicating a channel quality or requested modulation and coding scheme. The rate control component 344 may also determine a modulation and coding scheme based on a frame error rate target and a channel condition such as SNR.

The handover component 350 may include hardware and/or software code executable by a processor for managing a handover between the access point 310 and a neighbor AP (e.g., an access point that is accessible by one or more STAs associated with the access point 310). The handover component 350 may communicate with associated STAs using in-band messages. For example, the handover component 350 may provide handover signaling as downlink data for the scheduling component 326 to schedule. The handover component 350 may include an STA list 352 (e.g., in a memory) for storing information regarding each of the STAs associated with the access point 310. For example, the STA list 352 may receive channel quality measurements from each STA. The handover component 350 may determine whether to hand over an STA based on the channel quality measurements. The handover component 350 may add an STA to the STA list 352 when an STA is handed over to the access point 310 and remove an STA when the access point 310 hands over the STA to a neighbor AP. The handover component 350 may also include a neighbor list 354 (e.g., in a memory) for storing information regarding each neighbor AP of the access point 310. For example, the neighbor list 354 may include properties of the neighbor APs such as channels, timing, or other information an STA may use to connect to the neighbor AP.

The access point 310 may also include a backhaul interface 360 for sending and receiving various messages with the neighbor APs. The backhaul interface 360 may be a wired or wireless network interface. The backhaul interface 360 may be used by modem component 320 or one of its sub-components. For example, the handover component 350 may use the backhaul interface 360 to send a transfer request identifying an STA the access point 310 would like to handover and receive a transfer response indicating whether the neighbor AP has accepted a handover of the STA. The backhaul interface 360 may also transmit a handover update message indicating that a STA has acknowledged a handover command and should now be associated with the neighbor AP.

The transceiver 370 may include a radio frequency (RF) transmitter and/or RF receiver for transmitting a scheduled transmission. In an aspect, the transceiver 370 may include one or more transmit chain components and/or antennas. Further, the transceiver 370 may include one or more amplifiers. A transmission power may be adjusted by adjusting the gain applied to the one or more amplifiers. Further, the transceiver 370 may include an RF receiver for receiving RF signals from one or more STAs 115.

FIG. 4 illustrates a block diagram 400 showing an example wireless station 410. The wireless station 410 may be an example of a wireless station 115 (FIG. 1). In an aspect, for example, the wireless station 410 may be a sensor, robot, drone, or other electronic device using control data in a manufacturing, processing, or industrial facility. The wireless station 410 may include an application layer 415 that may run a low-latency application, a modem component 420 for managing MAC layer processing of wireless communications, and a transceiver 490 for wirelessly transmitting and receiving signals.

The application layer 415 may include hardware and/or software executable by a processor for running one or more applications. In an aspect, the application may be a low-latency application requiring low-latency communications. For example, the application may be a control application for a robot or drone. The application layer 415 may include or be running on a host processor and communicate with the modem component 420 via a modem driver. In an aspect, the application layer 415 may be configured to minimize latency of communications. In an aspect, for example, the application layer 415 may configure the driver to disable interrupt mitigation and frame aggregation. That is, when the application layer 415 has data for transmission, the application layer 415 may immediately forward the data to the modem component 420 without waiting for additional data to aggregate. The application layer 415 may also receive interrupts from the modem component 420 when each frame is received rather than waiting for aggregation with additional frames. As another example, the application layer 415 may use a raw socket with the modem component 420. The application layer 415 may directly generate MAC layer frames (e.g., MAC service data unit (SDU)) within the application rather than using multi-layer encapsulation to generate MAC layer frames. The application layer 415 may also keep a processor running in performance mode rather than switching to a low-power mode. In an aspect, the application layer 415 may set the modem component 420 to a promiscuous mode to forward all received traffic to the application layer 415 regardless of whether the received traffic is for the wireless station 410. A constant stream of traffic may prevent the processor from entering a low-power mode even when the application traffic has a low duty cycle. In another aspect, the application layer 415 may use a non-infrastructure mode. The non-infrastructure mode may remove beacons and other unnecessary overhead. These features of the application layer 415 may reduce latency between the application layer 415 and the modem component 420.

The modem component 420 may include hardware and/or software executable by a processor for managing MAC layer processing for wireless communications. In an aspect, the modem component 420 may provide a synchronized MAC layer protocol for communications with an AP 105 (FIG. 1). For example, the modem component 420 may provide for communication according to the channel structure illustrated in FIG. 2. The modem component 420 may include a synchronization component 430 for synchronizing with an AP 105, an uplink component 440 for transmitting uplink transmissions, a downlink component 450 for receiving downlink transmissions, a rate control component 460 for controlling a modulate rate or MCS, a boot-up component 470 for connecting to a low-latency network, and a handover component 480 for managing mobility between APs.

The synchronization component 430 may include hardware and/or software executable by a processor for receiving a downlink pilot 205 broadcast or otherwise transmitted by an AP 105. The synchronization component 430 may use the downlink pilot 205 to synchronize the timing of the wireless station 410 with the timing of the AP 105. For example, the timing for the uplink control blocks 220 and the traffic blocks 215 may be based on the downlink pilot 205.

The uplink component 440 may include hardware and/or software executable by a processor for managing uplink transmissions of the wireless station 410. The uplink component may include an uplink queue 442, reservation component 444, and grant component 446. The uplink component 440 may receive uplink data from the application layer 415 and temporarily store the uplink data in the uplink queue 442, which may include a memory. The reservation component 444 may be configured to transmit a reservation during an uplink control block 220 when the uplink queue 442 has uplink data. In an aspect, the reservation may be transmitted on a sub-set of OFDMA tones in an uplink control block 220 assigned to the wireless station 410. The grant component 446 may be configured to receive an uplink grant at the beginning of a traffic block 215. The grant component 446 may determine whether the uplink grant includes the station address of the wireless station 410. If the uplink grant includes the station address, the grant component 446 may determine the start of a time period for the wireless station 410 to transmit based on the order of the station addresses and the duration of each transmission. The uplink component 440 may determine which data from the uplink queue 442 to transmit during the time period based on the duration assigned to the wireless station 410 and an MCS determined by the rate control component 460. The uplink component 440 may provide the uplink transmission data to the transceiver 490.

The downlink component 450 include hardware and/or software executable by a processor for receiving downlink transmissions from an AP 105. The downlink transmissions may be received in a traffic block 215. The downlink component 450 may include a decoder 452 and an acknowledgment component 454. The decoder 452 may first decode a header portion of a downlink aggregated frame (DAF) to determine whether the DAF includes a frame for the wireless station 410. The downlink component 450 may determine a timing for a downlink frame for the wireless station 410 based on the header information. The decoder 452 may then decode the downlink frame for the wireless station 410. The acknowledgment component 454 may indicate whether the downlink frame was correctly received at the wireless station 410. In an aspect, the acknowledgment component 454 may transmit the acknowledgment after the DAF has completed using a sub-set of OFDMA frames selected based on the order of the wireless station 410 within the DAF.

The rate control component 460 may include hardware and/or software executable by a processor for determining a modulation rate and/or an MCS for the wireless station 410. In an aspect, the rate control component 460 may be in communication with the rate control component 344. For example, the rate control component 460 may determine a desired MCS for downlink frames based on previously received downlink frames and provide an MCS index to the rate control component 344. The rate control component 460 may also receive MCS information in an uplink grant to use for an uplink transmission. The rate control component 460 may receive an MCS in the header of a DAF to use for decoding a MPDU.

The boot-up component 470 may include hardware and/or software executable by a processor for connecting the wireless station 410 to an authentication AP1 105-a to join a low-latency network. The boot-up component 470 may perform a random access procedure on a dedicated boot-up channel to connect to the authentication AP1 105-a. The boot-up component 470 may then perform an authentication procedure to ensure that the wireless station 410 is allowed to access the low-latency network. The authentication AP1 105-a may then hand the wireless station 410 over to a serving AP2 105-b. If wireless station 410 ever becomes disconnected from the serving AP2 105-b, or another serving AP, the boot-up component 470 may reconnect to the low-latency network via the authentication AP1 105-a.

The handover component 480 may include hardware and/or software executable by a processor for managing mobility of the wireless station 410 within a low-latency network. The handover component 480 may be configured to measure the channel quality or signal strength of neighbor APs. The handover component 480 may determine when a handover to one of the neighbor APs should occur, or the handover component 480 may report the channel quality to the current serving AP2 105-b. In an aspect, the handover component 480 may include a dedicated transceiver for performing measurements. The dedicated transceiver may be tuned to wireless channels used by neighbor APs without interrupting communications between the wireless station 410 and the serving AP2 105-b.

The transceiver 490 may include an RF transmitter for transmitting a scheduled transmission. In an aspect, the transceiver 370 may include one or more transmit chain components and/or antennas. Further, the transceiver 370 may include one or more amplifiers. A transmission power may be adjusted by adjusting the gain applied to the one or more amplifiers. Further, the transceiver 490 may include an RF receiver for receiving RF signals from one or more APs 105.

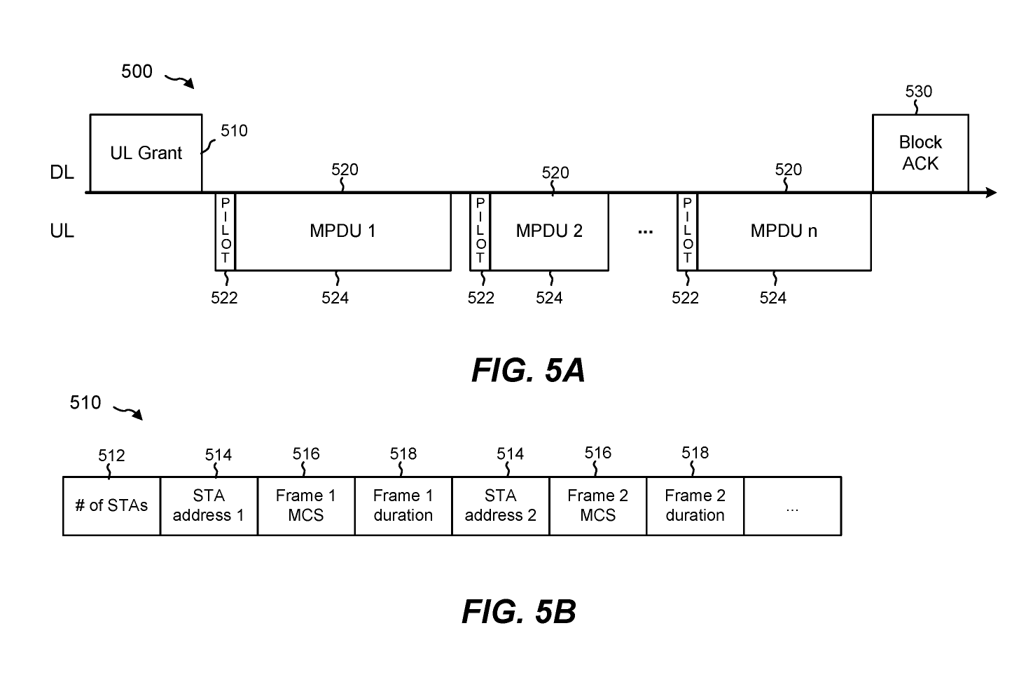

FIG. 5A shows a timing diagram illustrating an uplink frame 500 used for uplink transmissions. The uplink frame 500 may be an example of an uplink frame used during a traffic block 215. The uplink frame 500 may include an uplink grant 510, one or more uplink transmissions 520, and a block acknowledgment 530. FIG. 5B shows a diagram illustrating an example of the uplink grant 510 shown in FIG. 5A. The uplink grant 510 may include multiple fields including a number of stations 512 that have been allocated a time period for uplink transmission. The uplink grant 510 may also include an STA address 514, frame modulation and coding scheme 516, and frame duration 518 for each STA in the number of stations 512. Returning to FIG. 5A, each uplink transmission 520 may include a pilot 522 and a media access control (MAC) protocol data unit (PDU) 524. The pilot 522 may be relatively short compared to, for example, a pilot for a Wi-Fi transmission, because each associated STA 115 is already synchronized with the AP2 105-b using the downlink pilot 205. Accordingly, in an aspect, the pilot 522 may not include one or more training fields, which may be used in Wi-Fi to synchronize the receiving device. For example a pre-amble for a Wi-Fi transmission may be approximately 20 μs, whereas the pilot 522 may be approximately 4 μs. In an aspect, the pilot 552 may be a minimum time unit according to a selected OFDMA numerology for over the air transmissions. For example, the pilot 552 may be a single symbol. In another aspect, the duration of the pilot may be a time required for an automatic gain control (AGC) circuit to settle. Accordingly, the pilot 522 may be used for gain control. The MPDU 524 may carry the uplink data. The MPDU 524 may be encoded and modulated based on the frame modulation and coding scheme 516. The MPDU 524 may have a variable length as indicated in the frame duration 518.

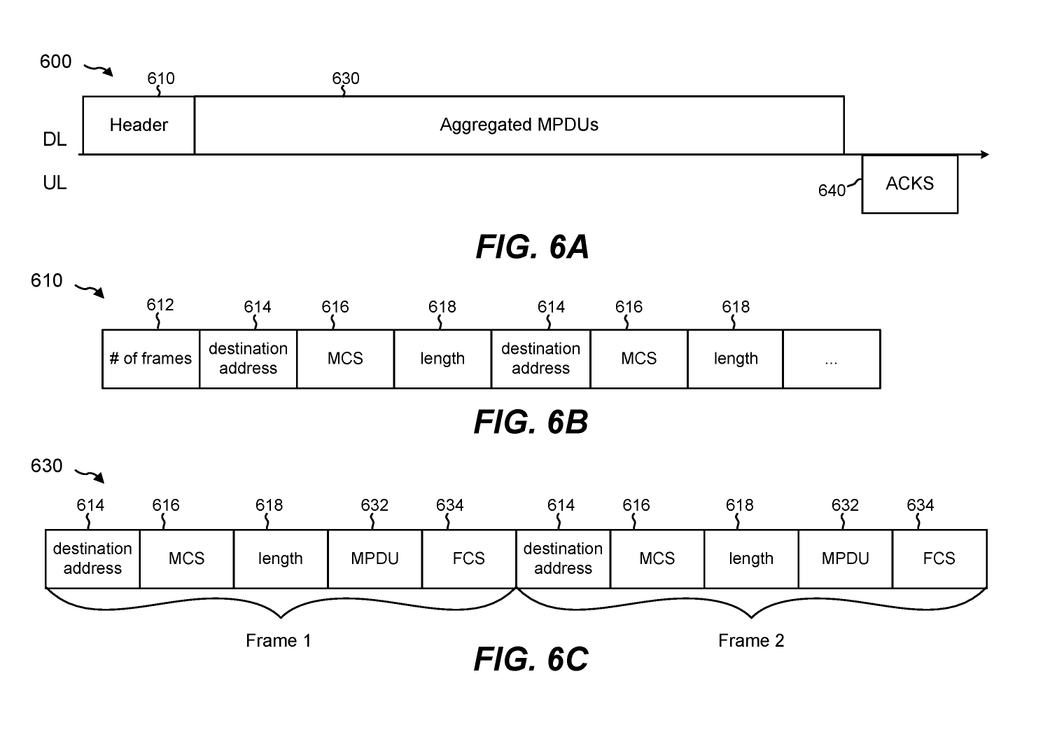

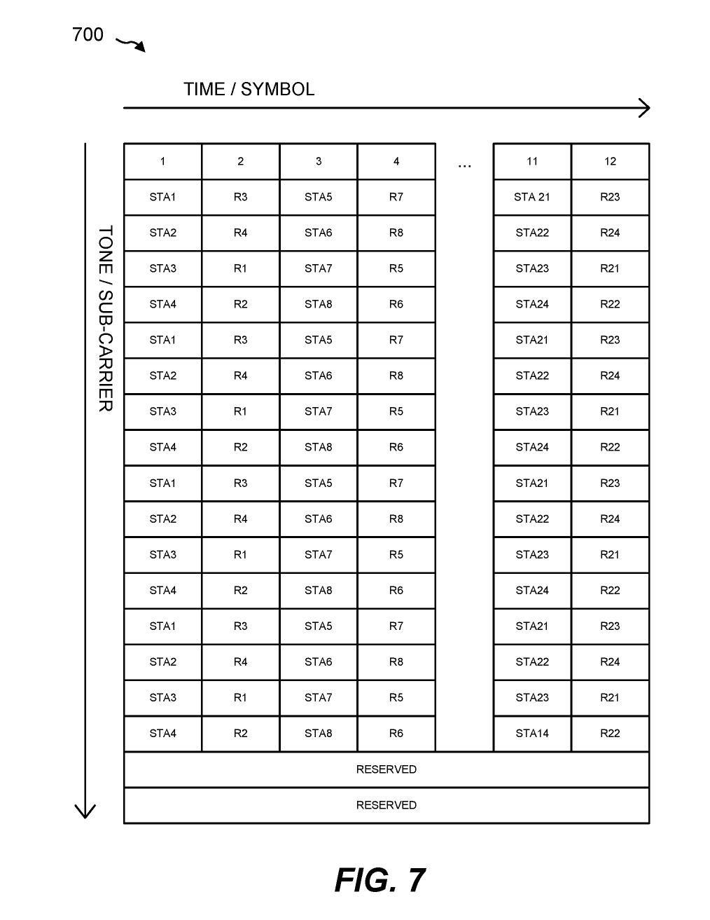

FIG. 6A shows a timing diagram illustrating a downlink frame 600 used for downlink transmissions. The downlink frame 600 may be an example of a downlink frame used during a traffic block 215. The downlink frame 600 may include a header 610, aggregated MPDUs 630 and acknowledgments 640. FIG. 6B shows a diagram illustrating an example header 610, which may include a number of frames 612, destination addresses 614 for each frame, a MCS 616 for each frame, and a length 618 for each frame. FIG. 6C shows a diagram illustrating an example aggregated MPDU 630 including one or more frames. In an aspect, each frame of the aggregated MPDU 630 may include a destination address 614, a MCS 616, a length 618, an MPDU 632, and a frame check sum (FCS) 634. In an aspect, the destination addresses 614, MCS 616, and length 618 for each frame may be included in either the header 610, the respective frame of the aggregated MPDUs 630, or both. Returning to FIG. 6A, the acknowledgments 640 may be transmitted by each STA included in the destination addresses 614. The acknowledgments 640 may be transmitted in a manner similar to the uplink control blocks 220 using OFDMA tones as described in further detail below with respect to FIG. 7. The tones for each STA to use in the acknowledgments 640 may be determined based on the order of the destination addresses 614 in the header 610.

FIG. 7 illustrates an example uplink control block 700. The uplink control block 700 may be an example of an uplink control block 220 shown in FIG. 2. The uplink control block 700 may be divided into a number of OFDMA resource elements. Each resource element may correspond to a tone or sub-carrier in the frequency domain and a symbol or time period in the time domain. The resource elements may be allocated to stations 115 for transmitting reservations. In an aspect, the uplink control block 700 may be formatted to allow all stations associated with an AP to quickly transmit reservations. In the example shown in FIG. 7, the uplink control block 700 may be 12 symbols long and occupy 20 MHz of bandwidth, which may be divided into 18 orthogonal tones. Each station may be assigned a pair of consecutive symbols and a sub-set of the tones (e.g., 4 tones). In an aspect, the tones for a station may be interlaced with tones of other stations. For example, four (4) stations may be assigned to each symbol pair and the assigned tones interlaced. In an aspect, the pair of consecutive symbols assigned to a station may use different sub-sets of tones. As illustrated in FIG. 7, for example, the sub-sets of tones may be offset by two tones. Using different sub-sets of tones may improve channel estimation. In some instances, two (2) tones in the channel may be reserved. In an aspect, the size of the uplink control block 700 may vary based on the number of stations associated with an AP. If a large number of stations is associated with an AP (e.g., more than 24), multiple control blocks may be used with stations only allowed to make a reservation on alternating control blocks.

The reservation for each station may include a pilot signal in the first symbol of the pair (e.g., odd symbols) and a phase modulated pilot signal in the second symbol of the pair (e.g., even symbols). In FIG. 7, for example, STA1 may be a pilot signal transmitted by a first station, and R1 may be STA1 phase modulated to indicate a reservation for the first station. For example, the first station may modulate the pilot signal STA1 with a +1 phase when the first station has uplink traffic and modulate the pilot signal STA1 with a −1 phase when the station has no uplink traffic. Accordingly, the AP may determine whether the first station has transmitted a reservation by comparing the first symbol (STA1) and the second symbol (R1). Similarly, STA2 may be the pilot signal transmitted by a second station, and R2 may be STA2 phase modulated to indicate a reservation for the second station. The use of a fixed pilot symbol for the reservations also allows the AP to use the reservations for channel estimation. The AP may, for example, determine a transmit power and/or MCS based on the channel estimation for the reservation.

In an aspect, the acknowledgments 640 may use a similar transmission format to the uplink control block 700. For example, multiple wireless stations may transmit an ACK using pilot signals and modulated pilot signals transmitted over sub-sets of OFDMA tones as in uplink control block 700. In an aspect, each wireless station may transmit an uplink pilot signal in a first symbol and transmit a phase modulated uplink pilot signal in a second symbol. For example, the station may modulate the pilot signal with a +1 phase when the station has successfully received the respective MPDU and modulate the pilot signal with a −1 phase when the station has not successfully received the respective MPDU. In an aspect, the wireless stations may transmit the acknowledgments using the same tones and symbols used for the reservations based on the station address. In another aspect, the wireless stations may use tones and symbols based on the order of the station addresses within the aggregated MPDU header 610. Accordingly, only those stations that were scheduled to receive a MPDU may transmit an ACK, and the acknowledgments 640 may use fewer symbols than the uplink control block 700. In another aspect, each STA 115 may be assigned a number of OFDMA tones for transmitting an ACK using a low modulation and coding scheme.

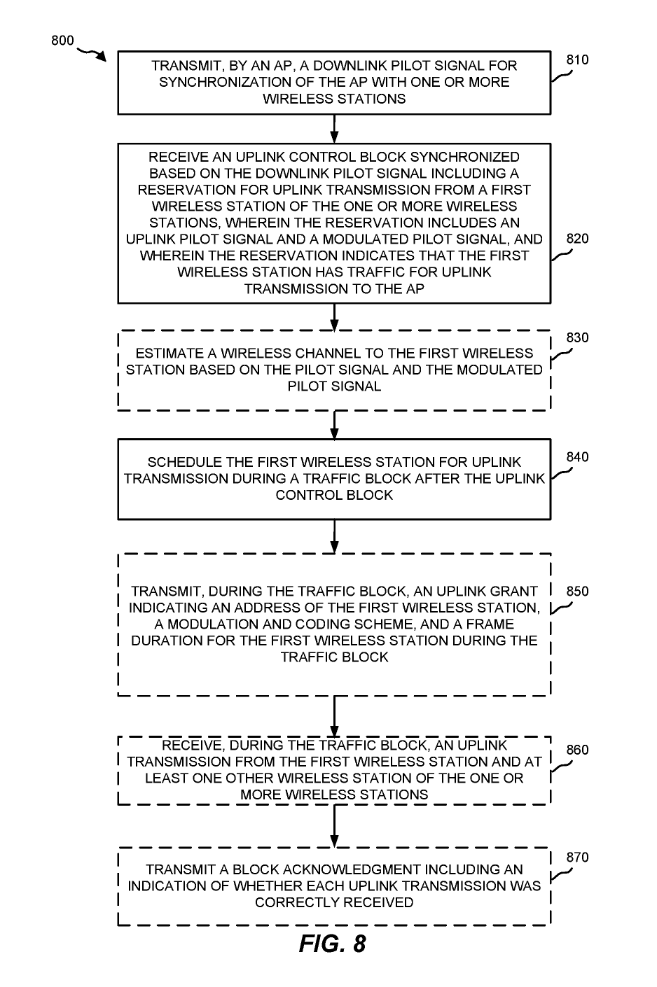

FIG. 8 shows a flow chart illustrating an example of aspects of a method 800 of providing low-latency synchronous communications in wireless networks. The method 800 may be performed by an access point such as a serving AP2 105-b or access point 310.

At block 810, the method 800 may include transmitting, by an AP, a downlink pilot signal for synchronization of the AP with one or more wireless stations. In an aspect, for example, the pilot signal generator 322 and the transceiver 370 may transmit the downlink pilot signal for synchronization of the AP with the one or more wireless stations.

At block 820, the method 800 may include receiving an uplink control block synchronized with the downlink pilot signal including a reservation for uplink transmission from a first wireless station of the one or more wireless stations, wherein the reservation includes an uplink pilot signal and a modulated pilot signal, and wherein the reservation indicates that the first wireless station has traffic for uplink transmission to the AP. In an aspect, for example, the uplink control block component 324 may receive an uplink control block including a reservation for uplink transmission from the first wireless station. In an aspect, the uplink pilot signal may be received in a first symbol of the uplink control block and the modulated pilot signal may be received in a second symbol of the uplink control block adjacent to the first symbol, the modulated pilot being phase modulated based on whether the first wireless station has traffic for uplink transmission to the AP. In another aspect, the reservation for the first wireless station may be received on a plurality of OFDMA tones. The plurality of OFDMA tones for the first wireless station may be interlaced with OFDMA tones for at least one other wireless station. The pilot signal may be received on a first subset of the plurality of OFDMA tones and the modulated pilot signal may be received on a second subset of the plurality of OFDMA tones.

At block 830, the method 800 may optionally include estimating a wireless channel to the first wireless station based on the pilot signal and the modulated pilot signal. In an aspect, for example, the channel estimator 334 may estimate the wireless channel to the first wireless station based on the pilot signal and the modulated pilot signal. For example, the channel estimator 334 may coherently demodulate the modulated pilot signal using the unmodulated pilot signal. The channel estimator 334 may then combine the two pilot signals to estimate the channel. In an aspect where the reservation is transmitted using a plurality of OFDMA tones, the channel estimator 334 may improve the channel estimation using the plurality of OFDMA tones.

At block 840, the method 800 may include scheduling the first wireless station for uplink transmission during a traffic block after the uplink control block. In an aspect, for example, the scheduling component 326 may schedule the first wireless station for uplink transmission during the traffic block after the uplink control block. In an aspect, the scheduling component 326 may also schedule additional wireless stations of the one or more wireless stations for uplink transmission during the traffic block. The scheduling component 326 may schedule each wireless station by determining a frame duration and modulation and coding scheme for the wireless station to use for an uplink transmission during the traffic block. The scheduling component 326 may prioritize the wireless stations when multiple wireless stations have data to transmit.

At block 850, the method 800 may optionally include transmitting, during the traffic block, an uplink grant indicating an address of the first wireless station, a modulation and coding scheme, and a frame duration for the first wireless station during the traffic block. In an aspect, for example, the uplink grant component 328 may transmit, during the traffic block, the uplink grant indicating the address of the first wireless station, the modulation and coding scheme, and the frame duration for the first wireless station. In an aspect, the uplink grant may also include a number of the one or more wireless stations scheduled for uplink transmission during the traffic block. For example, the uplink grant may also include an address of each additional wireless station, a respective modulation and coding scheme for each additional wireless station, and the frame duration for each additional wireless station.

At block 860, the method 800 may optionally include receiving, during the traffic block, an uplink transmission from the first wireless station and at least one other wireless station of the one or more wireless stations. In an aspect, for example, the decoder 342 may receive, during the traffic block, the uplink transmission from the first wireless station and at least one other wireless station of the one or more wireless stations.

At block 870, the method 800 may optionally include transmitting a block acknowledgment including an indication of whether each uplink transmission was correctly received. In an aspect, for example, the acknowledgment component 330 may transmit a block acknowledgment including an indication of whether each uplink transmission was correctly received. In an aspect, the block acknowledgment may be a bit-map corresponding to the uplink transmissions.

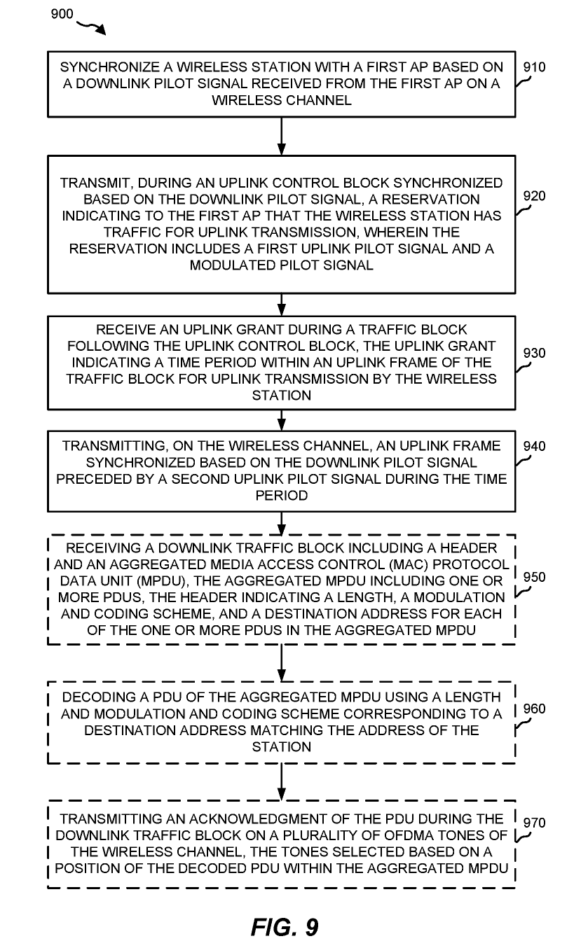

FIG. 9 shows a flow chart illustrating an example of aspects of a method 900 of providing low-latency synchronous communications in wireless networks. The method 900 may be performed by a wireless station such as a STA 115 or wireless station 410.

At block 910, the method 900 may include synchronizing a wireless station with a first access point (AP) based on a downlink pilot signal received from the first AP on a wireless channel. In an aspect, for example, the synchronization component 430 may synchronize the wireless station 410 with the first AP based on a downlink pilot 205 received from the first AP on a wireless channel.

At block 920, the method 900 may include transmitting, during an uplink control block synchronized with the downlink pilot signal, a reservation indicating to the first AP that the wireless station has traffic for uplink transmission, wherein the reservation includes an uplink pilot signal and a modulated pilot signal. In an aspect, for example, the reservation component 444 may transmit, during an uplink control block, a reservation indicating to the first AP that the wireless station has traffic for uplink transmission. In an aspect, the uplink pilot signal may be transmitted in a first symbol of the uplink control block and the modulated pilot signal may transmitted in a second symbol of the uplink control block adjacent to the first symbol, the modulated pilot being phase modulated based on whether the wireless station has traffic for uplink transmission to the AP. In an aspect, the uplink control block may include a plurality of OFDMA tones of the wireless channel, and the uplink reservation may be associated with a subset of the OFDMA tones based on an address of the wireless station.

At block 930, the method 900 may include receiving an uplink grant during a traffic block following the uplink control block, the uplink grant indicating a time period within an uplink frame of the traffic block for uplink transmission by the wireless station. In an aspect, for example, the grant component 446 may receive an uplink grant during a traffic block following the uplink control block, the uplink grant indicating a time period within an uplink frame of the traffic block for uplink transmission by the wireless station.

At block 940, the method 900 may include transmitting, on the wireless channel, an uplink frame synchronized with the downlink pilot signal during the time period based on the uplink grant. In an aspect, for example, the uplink component 440 may transmitting the uplink frame synchronized with the downlink pilot signal during the time period based on the uplink grant. In an aspect, the uplink frame may include an uplink pilot and a MPDU.

At block 950, the method 900 may optionally include receiving a downlink traffic block including a header and an aggregated media access control (MAC) protocol data unit (MPDU), the aggregated MPDU including one or more PDUs, the header indicating a length, a modulation and coding scheme, and a destination address for each of the one or more PDUs in the aggregated MPDU. In an aspect, for example, the decoder 452 may receive the downlink traffic block including the header and an aggregated MPDU.

At block 960, the method 900 may optionally include decoding a PDU of the aggregated MPDU using a length and modulation and coding scheme corresponding to a destination address matching the address of the station. In an aspect, for example, the decoder 452 may decode the PDU of the aggregated MPDU using the length and the modulation and coding scheme corresponding to a destination address matching the address of the station.

At block 970, the method 900 may optionally include transmitting an acknowledgment of the PDU during the downlink traffic block on a plurality of OFDMA tones of the wireless channel, the tones selected based on a position of the decoded PDU within the aggregated MPDU. In an aspect, for example, the acknowledgment component 454 may transmit the acknowledgment of the PDU during the downlink traffic block on the plurality of OFDMA tones of the wireless channel.

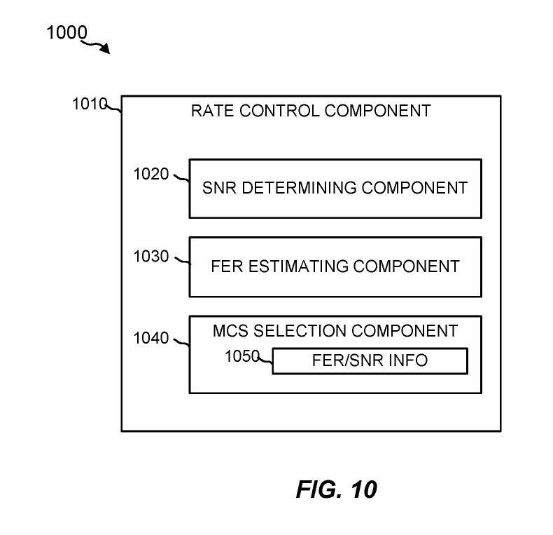

FIG. 10 shows a block diagram 1000 illustrating an example of a rate control component 1010. The rate control component 1010 may correspond to either the rate control component 344 (FIG. 3) or the rate control component 460 (FIG. 4). The rate control component 1010 may be configured to determine a modulation rate or a modulation and coding scheme (MCS) for a transmission. The rate control component 1010 may include an SNR determining component 1020, a FER estimating component 1030, and an MCS selection component 1040.

The SNR determining component 1020 may be configured to determine a signal-to-noise ratio of a received signal. In an aspect, for example, the SNR determining component 1020 may perform measurements of a received signal, or may acquire measurements from a decoder 342, 452.

The FER estimating component 1030 may include hardware and/or software executable by a processor for estimating a frame error rate (FER) based on a received frame. In an aspect, the FER estimating component 1030 may estimate the FER based on a single frame. In a low-latency application, a desired FER may be extremely low (e.g., 10⁻⁴). Accordingly, determining a FER based on a number of actually erroneously received frames may take a relatively long time because the erroneously received frames may be uncommon. The FER estimating component 1030 may estimate a FER for a single frame using likelihood ratios provided by a decoder. For example, a soft-decision Viterbi decoder may provide a likelihood ratio of a most likely path, which may be chosen as the decoded frame. The soft-decision Viterbi decoder may also provide a likelihood ratio of one or more alternative paths that were not chosen as the decoded frame. The FER estimating component 1030 may determine a ratio of the likelihood ratio of the chosen path to the sum of likelihood ratios of other likely paths for the frame. For example, the FER may be estimated according to the following equation:

$$FER = PR \{ C \neq \hat{c} \vert \vec{y} \} \approx 1 - \frac{Pr \{ \vec{y} \vert decoded path \}}{{\sum }_{i = 1}^{k} Pr \{ \vec{y} \vert i th likely path \}}$$

C may be the decoded code word, and ĉ may be the transmitted code word. \vec{y} may be a vector of the received signal for the decoded path. Pr{\vec{y}|path i} may be a function of a likelihood ratio of a decoded path, i. For example, for a Gaussian white noise channel,

$$Pr \{ \vec{y} \vert path i \} ∝ exp \{ - \frac{{E}_{s}}{{N}_{0}} {d}_{i}^{2} \} . \frac{{E}_{s}}{{N}_{0}}$$

may be a signal to noise measurement for the channel and dᵢ may be the Hamming distance between the received signal and its corresponding constellation point.

The FER estimating component 1030 may update historic FER and SNR information 1050 based on the estimated FER for each frame. For example, the FER estimating component 1030 may recalculate an FER/SNR curve based on the estimated FER.

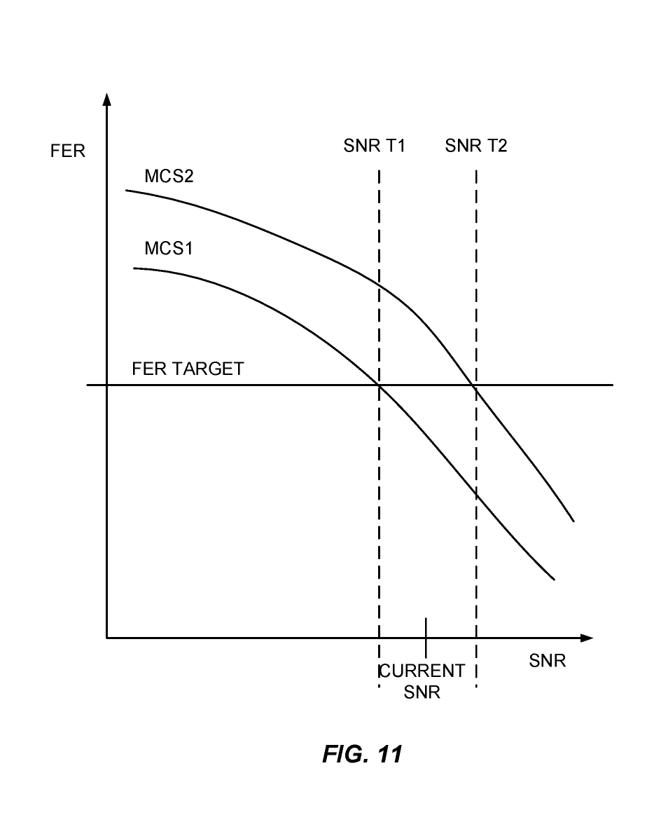

The MCS selection component 1040 may select a modulation rate or MCS based on historical FER and SNR information 1050 for each of a plurality of modulation and coding schemes. In aspect, the MCS selection component 1040 may store FER and SNR information 1050 for each MCS. FIG. 11 illustrates example FER/SNR curves. Generally, as SNR increases, the FER will decrease. The MCS selection component 1040 may determine an SNR threshold (e.g., SNR T1 and STR T2) required to meet a FER target for each MCS. The MCS selection component 1040 may then compare each SNR threshold to the current SNR measured by SNR determining component 1020. The MCS selection component 1040 may select the highest MCS where the SNR threshold is less than the current SNR.

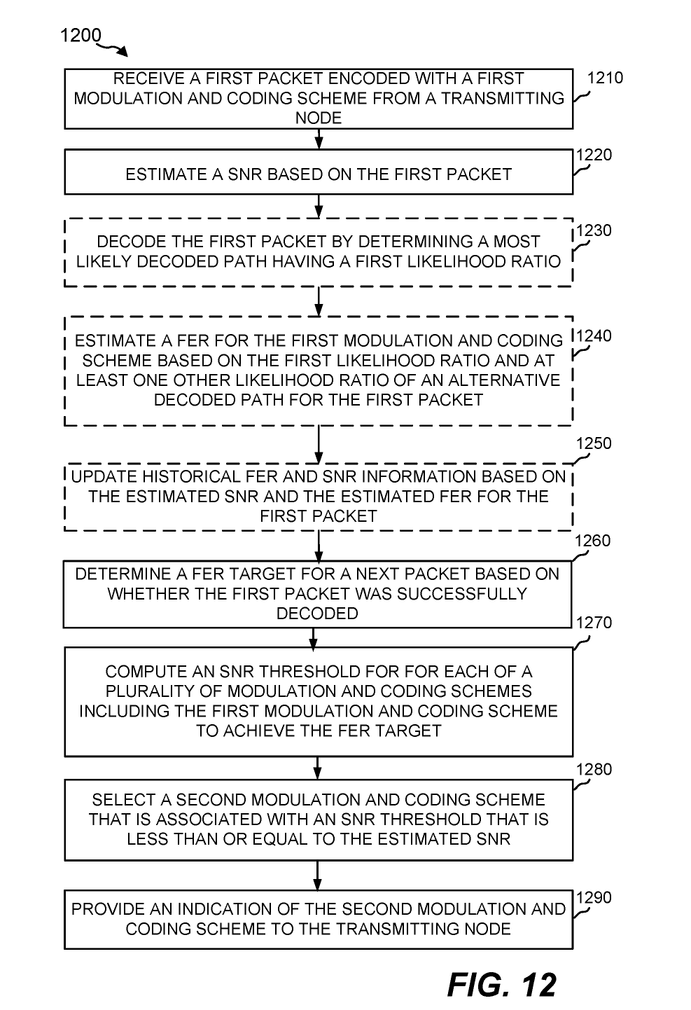

FIG. 12 shows a flow chart illustrating an example of aspects of a method 1200 of determining a modulation and coding scheme (MCS). The method 1200 may be performed by a rate control component 1010, which may be located in, for example, an access point 310 or wireless station 410.

At block 1210, the method 1200 may include receiving a first packet encoded with a first modulation and coding scheme from a transmitting node. In an aspect, for example, the rate control component 1010 may receive the first packet encoded with a first modulation and coding scheme from a transmitting node via a transceiver.

At block 1220, the method 1200 may include estimating a signal-to-noise ratio (SNR) based on the first packet. In an aspect, for example, the decoder 342 may estimate the SNR based on the first packet.

At block 1230, the method 1200 may optionally include decoding the first packet by determining a most likely decoded path having a first likelihood ratio. In an aspect, for example, a decoder 342, 452 may decode the first packet by determining the most likely decoded path having the first likelihood ratio. In an aspect, the decoding may be unsuccessful. For example, a cyclic redundancy check (CRC) of the packet may not pass.

At block 1240, the method 1200 may optionally include estimating a FER for the first modulation and coding scheme based on the first likelihood ratio and at least one other likelihood ratio of an alternative decoded path for the first packet. In an aspect, for example, the FER estimating component 1030 may estimate the FER for the first modulation and coding scheme based on the first likelihood ratio and at least one other likelihood ratio of an alternative decoded path for the first packet.

At block 1250, the method 1200 may optionally include updating historical FER and SNR information based on the estimated SNR and the estimated FER for the first packet. In an aspect, for example, the FER estimating component 1030 may update historical FER and SNR information 1050 based on the estimated SNR and the estimated FER for the first packet. For example, the FER estimating component 1030 may update historical FER and SNR information 1050 for the first modulation and coding scheme.

At block 1260, the method 1200 may include determining a FER target for a next packet based on whether the first packet was successfully decoded. In an aspect, for example, the rate control component 1010, the acknowledgment component 330, or the acknowledgment component 434 may determine the FER target. In an aspect, the FER target may be determined by adjusting a current FER target (e.g. the FER target used to determine the first modulation and coding scheme). For example, the FER target for the next packet may be determined by decreasing the current FER target when the first packet is decoded incorrectly. Accordingly, a FER target for a retransmission may have a lower FER target. If the first packet is decoded correctly, the FER target may remain the same, or may be reset to a default level in the case that the first packet was a retransmission.

At block 1270, the method 1200 may include computing an SNR threshold for each of a plurality of modulation and coding schemes including the first modulation and coding scheme to achieve the FER target. In an aspect, for example, the MCS selection component 1040 may compute the SNR threshold for each of a plurality of modulation and coding schemes including the first modulation and coding scheme to achieve the FER. The MCS selection component 1040 may compute the SNR threshold for each of a plurality of modulation and coding schemes to achieve the FER based on the historical FER and SNR information 1050. In an aspect, the historical FER and SNR information 1050 for the first modulation and coding scheme may be the updated historical FER and SNR information.

At block 1280, the method 1200 may include selecting a second modulation and coding scheme that is associated with a SNR threshold that is less than or equal to the estimated SNR, In an aspect, for example, the MCS selection component 1040 may select the second modulation and coding scheme that is associated with the SNR threshold that is less than or equal to the estimated SNR.

At block 1290, the method 1200 may include providing an indication of the second modulation and coding scheme to the transmitting node. In an aspect, for example, a transceiver 370, 490 may provide the second modulation and coding scheme to the transmitting node. In an aspect, the second modulation and coding scheme may be provided within a scheduled in-band transmission.

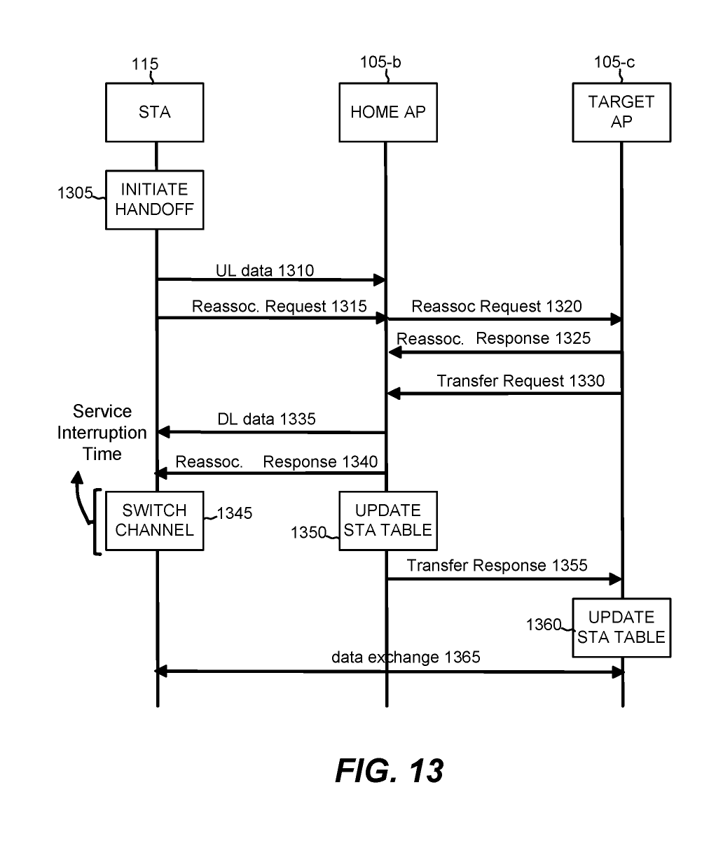

FIG. 13 shows a message diagram illustrating an example of a method 1300 for performing handover of a station. For example, a home AP (e.g., AP2 105-b) may handover a station 115 to a target AP (e.g., AP3 105-c). At block 1305, the STA 115 may initiate a handoff based on signal strength measurements for the AP2 105-b and AP3 105-c. For example, the STA 115 may determine that the signal strength of target AP3 105-c is stronger than the signal strength of home AP2 105-b. At 1310, the STA may send uplink data to the home AP2 105-b. At message 1315, the STA 115 may send a reassociation request indicating the target AP3 105-c to the home AP2 105-b. The reassociation request may be included in the uplink data. At message 1320, the home AP2 105-b may forward the reassociation request to the target AP3 105-c. At message 1325, the target AP3 105-c may respond with a reassociation response indicating that the request has been accepted. At message 1330, the target AP3 105-c may send a transfer request to the home AP2 105-b identifying the STA 115 to transfer. At message 1335, the home AP2 105-b may transmit downlink data to the STA 115. The downlink data may include a reassociation response 1340 commanding the STA 115 to switch to a channel of the target AP3 105-c. At block 1345, the STA 115 may switch channels. The STA 115 may experience a service interruption while actually switching channels. At block 1350, the home AP2 105-b may update an STA table to remove the STA 115 from the list of associated STAs. At message 1355, the home AP2 105-b may send a transfer response to the target AP3 105-c indicating that the STA 115 has been handed over. At block 1360, the target AP3 105-c may update its STA table to include the STA 115 on the list of associated APs. At message 1365, data exchange may occur between the STA 115 and the target AP3 105-c based on scheduling by the AP3 105-c.

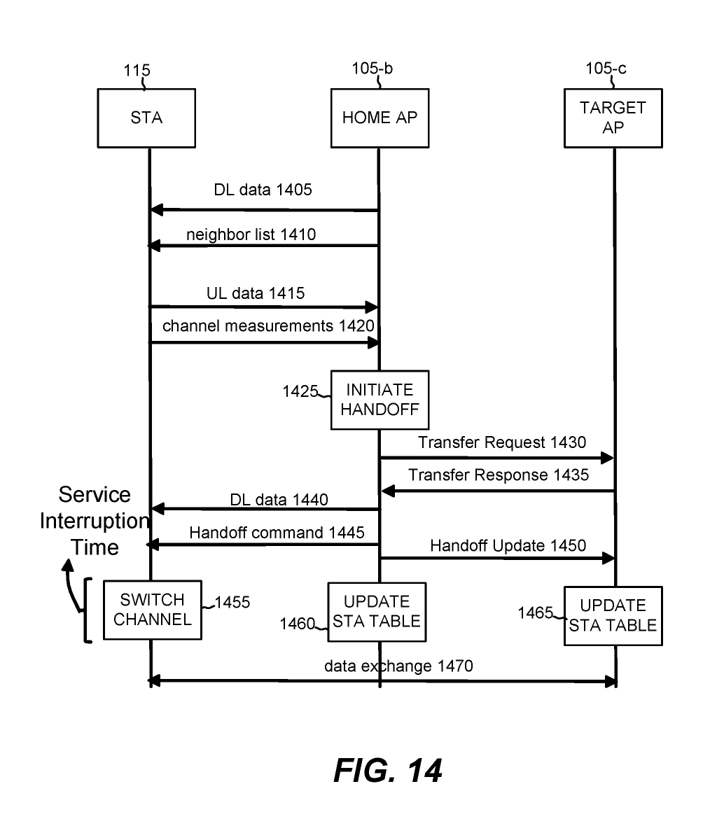

FIG. 14 shows a message diagram illustrating an example of a method 1400 for performing handover of a station. For example, a home AP (e.g., AP2 105-b) may handover a station 115 to a target AP (e.g., AP3 105-c). At message 1405, the home AP2 105-b may transmit downlink data to the STA 115. The downlink data may include a neighbor list 1410 indicating one or more neighbor APs that the STA 115 should monitor. At message 1415, the STA 115 may transmit uplink data to the home AP2 105-b. The uplink data may include channel measurements 1420 indicating, for example, signal strengths of the home AP2 105-b and a neighbor AP3 105-c. At block 1425, the home AP2 105-b may initiate a handoff from the home AP2 105-b to the target AP3 105-c. The home AP2 105-b may determine to initiate the handoff based on the received channel measurements. At message 1430, the home AP2 105-b may send a transfer request indicating the STA 115 that the home AP2 105-b would like to transfer. At message 1435, the target AP3 105-c may send a transfer response indicating that the target AP3 105-c has accepted the handover. At message 1440, the home AP2 105-b may transmit downlink data to the STA 115. The downlink data may include a handoff command 1445 indicating that the STA 115 should switch to the channel of the target AP3 105-c. At message 1450, the home AP2 105-b may send a handoff update to the target AP3 105-c indicating that the handover has been performed. At block 1455, the STA 115 may experience service interruption while switching channels. At block 1460, the home AP2 105-b may update the STA table to remove the STA 115 from the list of STAs associated with the home AP2 105-b. At block 1465, the target AP3 105-c may update its STA table to add the STA 115 to the list of STAs associated with the target AP3 105-c. In an aspect, blocks 1455, 1460, and 1465 may occur at substantially the same time such that STA 115 experiences little or no delay in scheduling. For example, the STA 115 may be scheduled in the next traffic block after switching channels. At message 1470, data exchange may occur between the target AP3 105-c and the STA 115 based on scheduling by the target AP3 105-c.

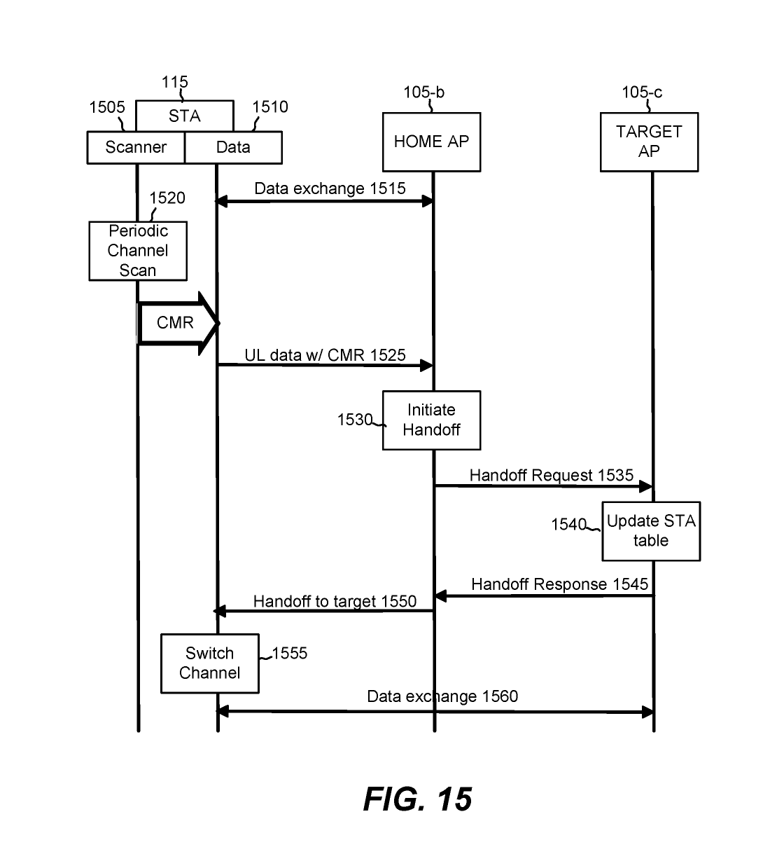

FIG. 15 shows a message diagram illustrating an example of a method 1500 for performing handover of a station. For example, a home AP (e.g., AP2 105-b) may handover a station 115 to a target AP (e.g., AP3 105-c). In an aspect, the STA 115 may include at least two transceivers capable of receiving signals on two different channels. One of the transceivers may be used as a dedicated scanner 1505. Another transceiver may be used as a dedicated data transceiver 1510. At message 1515, the STA 115 may exchange data with the home AP2 105-b using the data transceiver 1510. At block 1520, the dedicated scanner 1505 may perform a period channel scan. For example, the dedicated scanner 1505 may scan a channel of each neighbor AP. The dedicated scanner may pass a channel measurement report (CMR) to the data transceiver 1510. At block 1525, the data transceiver 1510 may transmit uplink data including the CMR to the home AP2 105-b. At block 1530, the home AP2 105-b may initiate a handoff from the home AP2 105-b to the target AP3 105-c based on the CMR. At message 1535, the home AP2 105-b may send a handoff request to the target AP3 105-c requesting handoff of the STA 115. At block 1540, the target AP3 105-c may update its STA table to add the STA 115 to the list of STAs associated with the target AP3 105-c. At message 1545, the target AP3 105-c may send a handoff response indicating that the target AP3 105-c has accepted the handoff. At message 1550, the home AP2 105-b may transmit a handoff command to the STA 115 indicating the target AP3 105-c. At block 1555, the data transceiver 1510 may switch to the channel of the target AP3 105-c. At message 1560, the target AP3 105-c may exchange data with the data transceiver 1510 based on scheduling by the target AP3 105-c.

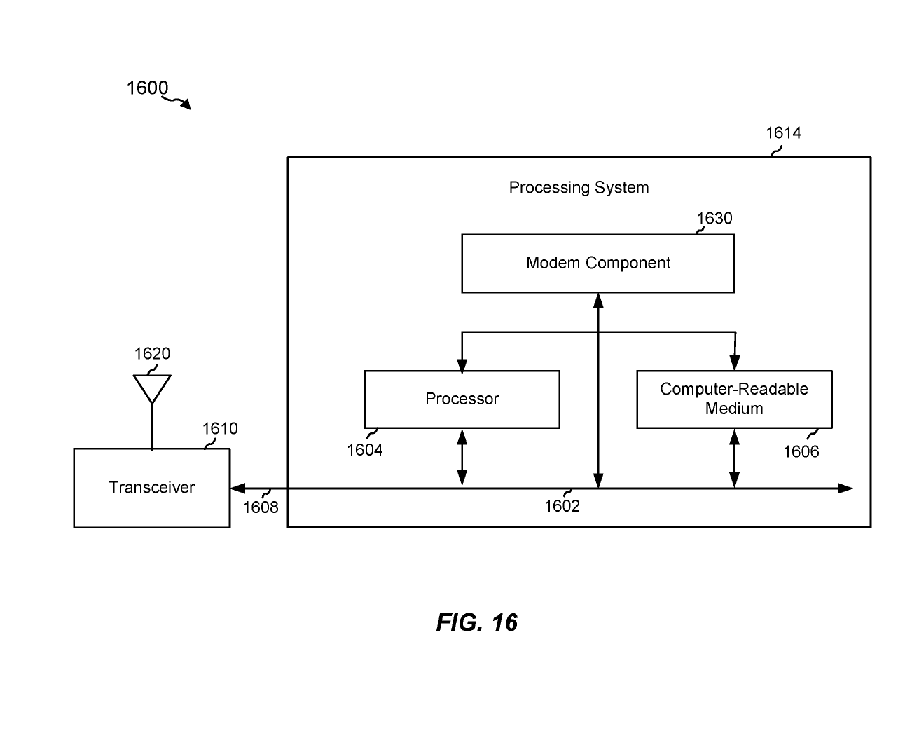

FIG. 16 shows a block diagram 1600 illustrating an example of a processing system 1614 configured for providing low-latency communications. In one aspect, the processing system 1614 may implement the access point 310 (FIG. 3). In another aspect, the processing system 1614 may implement the wireless station 410 (FIG. 4). The processing system 1614 may be implemented with a bus architecture, represented generally by the bus 1602. The bus 1602 may include any number of interconnecting buses and bridges depending on the specific application of the processing system 1614 and the overall design constraints. The bus 1602 links together various circuits including one or more processors and/or hardware modules, represented by the processor 1604, the modem component 1630 and the computer-readable medium/memory 1606. The bus 1602 may also link various other circuits such as timing sources, peripherals, voltage regulators, and power management circuits, which are well known in the art, and therefore, will not be described any further.

The processing system 1614 may be coupled to a transceiver 1610 via an interface 1608. The transceiver 1610 is coupled to one or more antennas 1620. The transceiver 1610 may provide a means for communicating with various other apparatus or devices over a transmission medium. The transceiver 1610 may receive a signal from the one or more antennas 1620, may extract information from the received signal, and may provide the extracted information to the processing system 1614, specifically the processor 1604. In addition, the transceiver 1610 may receive information from the processing system 1614, and based on the received information, may generate a signal to be applied to the one or more antennas 1620. In an aspect, the transceiver 1610 may be an example of the transceiver 370 (FIG. 3) or the transceiver 490 (FIG. 4). In an aspect, the modem component 1630 includes a separate processor (not shown) that implements any of the subcomponents of the modem component 320 (FIG. 3) or the modem component 420 (FIG. 4). The processing system 1614 includes the processor 1604 coupled to the computer-readable medium/memory 1606, and/or to the modem component 1630, which may be an example of the modem component 320 (FIG. 3) or the modem component 420 (FIG. 4). The processor 1604 is responsible for general processing, including the execution of software stored on the computer-readable medium/memory 1606. The software, when executed by the processor 1604, causes the processing system 1614 to perform the various functions described in the disclosure for communicating in a low-latency WLAN network. In an aspect, the modem component 1630 and any of the subcomponents of the modem component 320 (FIG. 3) or the modem component 420 (FIG. 4) may be implemented by the processor 1604 executing software. The computer-readable medium/memory 1606 may also be used for storing data that is manipulated by the processor 1604 when executing software. The modem component 1630 may be implemented by a software module running in the processor 1604, resident/stored in the computer readable medium/memory 1606, a hardware module coupled to the processor 1604, or some combination thereof. In some instances, the processor 1604 and the computer readable medium/memory 1606 may be used to perform functions, operations, or features described herein with respect to one or more of the components of the modem component 1630.

For example, the processing system 1614, when acting as an AP, may perform the method 800 (FIG. 8) and/or the method 1200 (FIG. 12). As another example, the processing system 1614, when acting as an STA, may perform the method 900 (FIG. 9) and/or the method 1200 (FIG. 12). The processing system 1614 may also perform a handover according to method 1300 (FIG. 13), method 1400 (FIG. 14), or method 1500 (FIG. 15) acting as an STA 115, serving AP2 105-b, or target AP3 105-c.

In an aspect, for example, the processing system 1614 may transmit a downlink pilot signal, receive an uplink control block, estimate a wireless channel to a wireless station, and schedule the wireless station for uplink transmission. The processing system 1614, when acting as an STA may synchronize a wireless station with a first access point, transmit a reservation during an uplink control block, receive an uplink grant, and transmit an uplink frame based on the uplink grant. In another aspect, the processing system 1614 may perform rate control. For example, the processing system 1614 may receive a first packet encoded with a first MCS, estimate an SNR based on the first packet, determine a FER target, compute an SNR threshold for a plurality of MCSs, select a second MCS that is associated with an SNR threshold that is less than or equal to the estimated SNR, and provide an indication of the second MCS to a transmitting node.

The apparatus and methods have been described in the detailed description and illustrated in the accompanying drawings by various elements comprising blocks, modules, components, circuits, steps, processes, algorithms, and the like. These elements, or any portion thereof, either alone or in combinations with other elements and/or functions, may be implemented using electronic hardware, computer software, or any combination thereof. Whether such elements are implemented as hardware or software depends upon the particular application and design constraints imposed on the overall system. In an aspect, the term “component” as used herein may be one of the parts that make up a system and may be divided into other components.

By way of example, an element, or any portion of an element, or any combination of elements may be implemented with a “processing system” that includes one or more processors. A processor may include a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A non-transitory computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), static RAM (SRAM), dynamic RAM (DRAM), synchronous dynamic RAM (SDRAM); double date rate RAM (DDRAM), read only memory (ROM), programmable ROM (PROM), erasable PROM (EPROM), electrically erasable PROM (EEPROM), a general register, or any other suitable non-transitory medium for storing software.

The various interconnections within a processing system may be shown as buses or as single signal lines. Each of the buses may alternatively be a single signal line, and each of the single signal lines may alternatively be buses, and a single line or bus might represent any one or more of a myriad of physical or logical mechanisms for communication between elements. Any of the signals provided over various buses described herein may be time-multiplexed with other signals and provided over one or more common buses.

The various aspects of this disclosure are provided to enable one of ordinary skill in the art to practice the present invention. Various modifications to examples of implementations presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the examples of implementations described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method for wireless communications, comprising:
transmitting, by an access point (AP), a downlink pilot signal for synchronization of the AP with one or more wireless stations;
receiving an uplink control block synchronized with the downlink pilot signal including a reservation for uplink transmission from a first wireless station of the one or more wireless stations, wherein the reservation includes an uplink pilot signal and a modulated pilot signal, and wherein the reservation indicates that the first wireless station has traffic for uplink transmission to the AP; and
scheduling the first wireless station for uplink transmission during a traffic block after the uplink control block.

2. The method of claim 1, further comprising estimating a wireless channel to the first wireless station based on the uplink pilot signal and the modulated pilot signal.

3. The method of claim 1, wherein the uplink pilot signal is received in a first symbol of the uplink control block and the modulated pilot signal is received in a second symbol of the uplink control block adjacent to the first symbol, the modulated pilot signal being phase modulated based on whether the first wireless station has traffic for uplink transmission to the AP.

4. The method of claim 1, further comprising transmitting, during the traffic block, an uplink grant indicating an address of the first wireless station, a modulation and coding scheme, and a frame duration for the first wireless station during the traffic block.

5. The method of claim 1, further comprising:
receiving, during the traffic block, an uplink transmission from the first wireless station and at least one other wireless station of the one or more wireless stations; and
transmitting a block acknowledgment including an indication of whether each uplink transmission was correctly received.

6. The method of claim 1, further comprising transmitting, during the traffic block, a header and an aggregated medium access control (MAC) protocol data unit (MPDU), the aggregated MPDU including one or more PDUs, the header indicating a length, a modulation and coding scheme, and a destination address for each of the one or more PDUs in the aggregated MPDU, wherein each destination address identifies a corresponding wireless station from the one or more wireless stations.

7. The method of claim 1, further comprising:
receiving, in the uplink transmission from a wireless station of the one or more wireless stations scheduled for uplink transmission, a channel measurement of a neighbor AP;
determining that the wireless station should be handed over to the neighbor AP based on the channel measurement;
sending a handover command to the wireless station in a downlink frame of a second traffic block, the handover command ordering the wireless station to change to a channel of the neighbor AP; and
sending a handover update to the neighbor AP in response to receiving an acknowledgment of the handover command from the wireless station, the handover update indicating that the wireless station is now associated with the neighbor AP.

8. The method of claim 1, further comprising:
receiving a transfer request from a neighbor AP for an additional wireless station to the one or more wireless stations synchronized with the AP;
determining that the AP can accept the additional wireless station;
sending a transfer response to the neighbor AP;
receiving a handoff update indicating that the additional wireless station has been handed over; and
receiving another uplink control block including a reservation from the additional wireless station.

9. A method for wireless communications, comprising:
synchronizing a wireless station with a first access point (AP) based at least in part on a downlink pilot signal received from the first AP on a wireless channel;
transmitting, during an uplink control block synchronized with the downlink pilot signal, a reservation indicating to the first AP that the wireless station has traffic for uplink transmission, wherein the reservation includes an uplink pilot signal and a modulated pilot signal;
receiving an uplink grant during a traffic block following the uplink control block, the uplink grant indicating a time period within the traffic block for uplink transmission by the wireless station; and
transmitting, on the wireless channel, an uplink frame synchronized with the downlink pilot signal during the time period based on the uplink grant.

10. The method of claim 9, wherein the uplink pilot signal is transmitted in a first symbol of the uplink control block and the modulated pilot signal is transmitted in a second symbol of the uplink control block adjacent to the first symbol, the modulated pilot signal being phase modulated based on whether the wireless station has traffic for uplink transmission to the AP.

11. The method of claim 9, wherein the uplink control block includes a plurality of orthogonal frequency division multiple access (OFDMA) tones of the wireless channel, and the reservation is associated with a subset of the OFDMA tones based on an address of the wireless station.

12. The method of claim 9, further comprising:
receiving a downlink traffic block including a header and an aggregated media access control (MAC) protocol data unit (MPDU), the aggregated MPDU including one or more PDUs, the header indicating a length, a modulation and coding scheme, and a destination address of a respective wireless station for each of the one or more PDUs in the aggregated MPDU;
decoding a PDU of the aggregated MPDU using the length and the modulation and coding scheme corresponding to the destination address matching an address of the wireless station; and
transmitting an acknowledgment of the PDU during the downlink traffic block on a plurality of OFDMA tones of the wireless channel, the OFDMA tones selected based on a position of the decoded PDU within the aggregated MPDU.

13. The method of claim 9, wherein the uplink grant includes a permitted duration of the time period, the method further comprising:
determining a first modulation rate for the uplink transmission; and
determining a second modulation rate for an uplink retransmission, wherein the second modulation rate is lower than the first modulation rate, and wherein the uplink transmission and the uplink retransmission are transmitted within the permitted duration.

14. The method of claim 9, further comprising:
performing a random access procedure to connect the wireless station to an authorization AP on a dedicated boot-up channel; and
performing a handover from the authorization AP to the first AP prior to any communication between the wireless station and the first AP.

15. The method of claim 9, further comprising:
receiving a MAC layer frame from an application for the uplink transmission, wherein transmitting the uplink MPDU comprises transmitting the MAC layer frame.

16. The method of claim 9, further comprising:
maintaining a neighbor list table including connection information for a plurality of APs in a network including channels used by each of the plurality of APs;
determining a signal strength for a neighbor AP using a channel measurement transceiver;
reporting the signal strength in the uplink MPDU;
receiving a handoff command in the traffic block indicating a second channel of the neighbor AP;
switching to the second channel; and
synchronizing the wireless station with the neighbor AP based on a received downlink pilot signal on the second channel.

17. An apparatus for wireless communications, comprising:
a transceiver;
a memory that stores instructions; and
a processor communicatively coupled to the transceiver and the memory, the processor configured to execute the instructions to:
transmit, via the transceiver, from an access point (AP), a downlink pilot signal for synchronization of the AP with one or more wireless stations; and
receive, via the transceiver, an uplink control block synchronized with the downlink pilot signal including a reservation for uplink transmission from a first wireless station of the one or more wireless stations, wherein the reservation includes an uplink pilot signal and a modulated pilot signal, and wherein the reservation indicates that the first wireless station has traffic for uplink transmission to the AP; and
schedule the first wireless station for uplink transmission during a traffic block after the uplink control block.

18. The apparatus of claim 17, wherein the processor is configured to execute the instructions to estimate a wireless channel to the first wireless station based on the uplink pilot signal and the modulated pilot signal.

19. The apparatus of claim 17, wherein the uplink pilot signal is received in a first symbol of the uplink control block and the modulated pilot signal is received in a second symbol of the uplink control block adjacent to the first symbol, the modulated pilot signal being phase modulated based on whether the first wireless station has traffic for uplink transmission to the AP.

20. The apparatus of claim 17, wherein the processor is configured to execute the instructions to transmit, during the traffic block, an uplink grant indicating an address of the first wireless station, a modulation and coding scheme, and a frame duration for the first wireless station during the traffic block.

21. The apparatus of claim 17, wherein the processor is configured to execute the instructions to:
receive, during the traffic block, an uplink transmission from the first wireless station and at least one other wireless station of the one or more wireless stations; and
transmit a block acknowledgment including an indication of whether each uplink transmission was correctly received.

22. The apparatus of claim 21, wherein the processor is configured to execute the instructions to transmit, during the traffic block, a header and an aggregated medium access control (MAC) protocol data unit (MPDU), the aggregated MPDU including one or more PDUs, the header indicating a length, a modulation and coding scheme, and a destination address for each of the one or more PDUs in the aggregated MPDU, wherein each destination address identifies a corresponding wireless station from the one or more wireless stations.

23. The apparatus of claim 17, wherein the processor is configured to execute the instructions to:
receive, in the uplink transmission from a wireless station of the one or more wireless stations scheduled for uplink transmission, a channel measurement of a neighbor AP;
determine that the wireless station should be handed over to the neighbor AP based on the channel measurement;
send a handover command to the wireless station in a downlink frame of a second traffic block, the handover command ordering the wireless station to change to a channel of the neighbor AP; and
send a handover update to the neighbor AP in response to receiving an acknowledgment of the handover command from the wireless station, the handover update indicating that the wireless station is now associated with the neighbor AP.

24. An apparatus for wireless communications, comprising:
a transceiver;
a memory that stores instructions; and
a processor communicatively coupled to the memory and the transceiver, the processor configured to execute the instructions to:
synchronize a wireless station with a first access point (AP) based on a downlink pilot signal received from the first AP on a wireless channel;
transmit, via the transceiver, during an uplink control block synchronized with the downlink pilot signal, a reservation indicating to the first AP that the wireless station has traffic for uplink transmission, wherein the reservation includes an uplink pilot signal and a modulated pilot signal; and
receive, via the transceiver, an uplink grant during a traffic block following the uplink control block, the uplink grant indicating a time period within the traffic block for uplink transmission by the wireless station; and
transmit, on the wireless channel, via the transceiver, an uplink frame synchronized with the downlink pilot signal during the time period based on the uplink grant.

25. The apparatus of claim 24, wherein the uplink pilot signal is transmitted in a first symbol of the uplink control block and the modulated pilot signal is transmitted in a second symbol of the uplink control block adjacent to the first symbol, the modulated pilot signal being phase modulated based on whether the wireless station has traffic for uplink transmission to the AP.

26. The apparatus of claim 24, wherein the uplink control block includes a plurality of OFDMA tones of the wireless channel, and the reservation is associated with a subset of the OFDMA tones based on an address of the wireless station.

27. The apparatus of claim 24, wherein the processor is configured to execute the instructions to:
receive a downlink traffic block including a header and an aggregated media access control (MAC) protocol data unit (MPDU), the aggregated MPDU including one or more PDUs, the header indicating a length, a modulation and coding scheme, and a destination address of a respective wireless station for each of the one or more PDUs in the aggregated MPDU;
decode a PDU of the aggregated MPDU using the length and the modulation and coding scheme corresponding to the destination address matching an address of the wireless station; and
transmit an acknowledgment of the PDU during the downlink traffic block on a plurality of OFDMA tones of the wireless channel, the OFDMA tones selected based on a position of the decoded PDU within the aggregated MPDU.

28. The apparatus of claim 24, wherein the uplink grant includes a permitted duration of the time period, and wherein the processor is configured to execute the instructions to:
determine a first modulation rate for the uplink transmission; and
determine a second modulation rate for an uplink retransmission, wherein the second modulation rate is lower than the first modulation rate, and wherein the uplink transmission and the uplink retransmission are transmitted within the permitted duration.

29. The apparatus of claim 24, wherein the processor is configured to execute the instructions to:
perform a random access procedure to connect the wireless station to an authorization AP on a dedicated boot-up channel; and
perform a handover from the authorization AP to the first AP prior to any communication between the wireless station and the first AP.

30. The apparatus of claim 24, wherein the processor is configured to execute the instructions to:
maintain a neighbor list table including connection information for a plurality of APs in a network including channels used by each of the plurality of APs;
determine a signal strength for a neighbor AP using a channel measurement transceiver;
report the signal strength in the uplink MPDU;
receive a handoff command in the traffic block indicating a second channel of the neighbor AP;
switch to the second channel; and
synchronize the wireless station with the neighbor AP based on a received downlinkpilot signal on the second channel.
